(19) United States
(12) Patent Application Publication
(10) Pub. No.: US 2026/0093924 A1
(43) Pub. Date: Apr. 2, 2026

(54) SYSTEM AND METHOD FOR CONTEXTUAL ADAPTATION OF CAPABILITY INTENT ACTIONS RESPONSIVE TO A USER QUERY INPUT BY AN ARTIFICIAL INTELLIGENCE PRODUCTIVITY TOOL SOFTWARE MODULE EXECUTING ON AN INFORMATION HANDLING SYSTEM

(71) Applicant: Dell Products LP, Round Rock, TX (US)

(72) Inventors: Chih-Chien Hsiao, Taipei City (TW); Jacob Mink, Cedar Park, TX (US); Srikanth Kondapi, Austin, TX (US)

(73) Assignee: Dell Products LP, Round Rock, TX (US)

(21) Appl. No.: 18/904,585

(22) Filed: Oct. 2, 2024

(51) Int. Cl. G06F 40/30; G10L 15/26

(52) U.S. Cl. CPC G06F 40/30; G10L 15/26

(57) ABSTRACT

An information handling system includes a hardware processor executing computer-readable program code instructions of a system component and user context discovery software application to gather system component context telemetry data describing operating hardware, hardware modes, and hardware resource consumption and user operating context telemetry data describing current and historic software application use and executing an artificial intelligence (AI) productivity tool software module to receive user-query input, and to identify a responsive capability of an AI productivity tool enablable software application to select and execute at least one capability intent action responsive to the user-query input using, as input, the system/component context telemetry data and user operating context telemetry data to select and adapt the responsive capability intent action for execution in context of the information handling system and the user making the user-query input.

### FIELD OF THE DISCLOSURE

The present disclosure generally relates to execution of computer-readable program code instructions of an artificial intelligence (AI) productivity tool software module to identify a capability associated with the execution of an AI productivity tool-enablable software application responsive to user-query inputs. The present disclosure more specifically relates systems and methods of executing computer-readable program code instructions for the AI productivity tool software module to identify and select among capabilities of one or more AI productivity tool-enablable software applications responsive to a user-query input and make adaptations based on context of system operation context and user context.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more workplace productivity applications or other application such as for teleconferencing, word processing, sales systems, business software, gaming applications, or the like. Further, the information handling system may include an on the box (OTB) artificial intelligence (AI) productivity tool software module employing machine learning (ML) models stored locally at the information handling system, as installed by a manufacturer of the information handling system, for optimizing user productivity and information handling system performance.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system that includes computer-readable program code instructions of an AI productivity tool software module to identify and select among a plurality of responsive capabilities of AI productivity tool-enablable software applications responsive to a user query input and adapt selected capabilities based on gathered system/component context telemetry data and/or user operating context telemetry data according to an embodiment of the present disclosure;

FIG. 2 is a graphic and block diagram illustrating an information handling system that includes computer-readable program code instructions of an AI productivity tool software module to identify, select among, and adapt a plurality of ML module algorithms to determine AI productivity tool-enablable software applications having responsive software services, operations, or other capabilities to a user query input based on system/component context telemetry data and/or user operating context telemetry data gathered by a system component and user context discovery software application according to another embodiment of the present disclosure;

FIG. 3 is a flow diagram showing a method of executing computer readable code instructions for selecting among a plurality of capabilities based on gathered system/component context telemetry data and/or user operating context telemetry data, and adapting at least one selected capability of one or more AI productivity tool-enablable software applications by an AI productivity tool software module responsive to a user query input according to an embodiment of the present disclosure; and

FIG. 4 is a flow diagram showing another method of executing computer readable code instructions for identifying one or more capabilities of one or more AI productivity tool-enablable software applications by an AI productivity tool software module responsive to a user query input and adapting select responsive capabilities based on gathered system/component context telemetry data and/or user operating context telemetry data according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Information handling systems, including computers, mobile computers, and smart phones are increasingly employing artificial intelligence (AI) productivity tool software applications to optimize user productivity and performance of the information handling systems. Examples of such artificial intelligence methodologies includes chatbots to simulate conversations between the information handling system and the user. In an example embodiment of the present disclosure, an AI productivity tool software module may be used to trigger changes in firmware or hardware (e.g., changing display or power settings), software, or processes of one or more AI productivity tool-enablable software applications (e.g., send an e-mail or text message, schedule a meeting, or modify firmware or hardware via driver software). Various machine learning models may be used to support such functionality, including automatic speech recognition (ASR) models, text embedding models, and similarity search models that may work in combination with one another to identify a capability intent action that may be taken by an AI productivity tool-enablable software applications as similarity matched to a request within a received user-query input according to embodiments herein. For example, an AI productivity tool software module and an operatively-coupled AI productivity tool subagent may be capable of determining a user’s intent for correlation to a capability intent action that is responsive to a user-query input. The AI productivity tool software module and subagent matches a determined query intent with a capability intent known to be achievable, based on published or established capabilities by a particular of one or more AI productivity tool-enablable software applications executing at the information handling system. In some examples, once the AI productivity tool-enablable software application capable of performing the user-requested capability intent action within the user-query input is identified, the AI productivity tool subagent may identify an application programming interface (API) call that, when executed, may cause the AI productivity tool-enablable software application associated with the identified capability to perform that identified, responsive capability.

As described, however, while the AI productivity tool subagent is identifying the AI productivity tool-enablable software application that can provide the capability intent action identified from the user-query input, an intent identification software application such as an AI productivity sub-agent executing one or more ML model algorithms may be limited to mapping of a specifically-identified user intent action to a capability of an AI productivity tool-enablable software application used to execute that intent action. In some examples, this mapping of identified user intent actions to capabilities associated with any given AI productivity tool-enablable software application does not account for or depend on system/component context telemetry data and/or user operating context telemetry data and is left for developers to make these mapping decisions. The inability of the intent identification software application to consider user operating context telemetry data and system/component context telemetry data at the intent identification software application in an information handling system environment that consistently changes creates a gap between what the user may have intended to be completed with the user-query input and the capability intent actions ultimately carried out. Customization of the user-requested capability intent action for responses accounting for user operating context telemetry data and system/component context telemetry data can further increase the useability and user-satisfaction of the information handling system.

The present specification describes systems and methods of selecting a responsive capability intent action of an artificial intelligence (AI) productivity tool-enablable software application by an AI productivity tool software module in response to a received user query input based, in part, on contextual telemetry data for a user and the information handling system. The present specification describes systems and methods of applying modifications, based on contextual telemetry data for a user and the information handling system, to a selected responsive capability intent action of an artificial intelligence (AI) productivity tool-enablable software application by an AI productivity tool software module in response to a received user query input. The system and method may include a hardware processor to execute computer-readable program code instructions of a system component and user context discovery software application. Execution of the system component and user context discovery software application may initiate the gathering of system/component context telemetry data describing operating hardware, hardware modes, and hardware resource consumption. Additionally, execution of the system component and user context discovery software application may initiate the gathering of user operating context telemetry data describing a user operating the information handling system and current and historic software application use by that user. In an embodiment, the hardware processor may execute computer-readable program code instructions of an artificial intelligence (AI) productivity tool software module to receive user-query input from a user of the information handling system via an input/output device.

In an embodiment, the systems and methods further includes the hardware processor executing computer-readable program code instructions of the AI productivity tool software module to invoke a machine learning (ML) model algorithm to identify a plurality of responsive capabilities of AI productivity-tool enablable software applications responsive to the user-query input and select at least one responsive capability intent action based on input of the system/component context telemetry data and the user operating context telemetry data to select the at least one responsive capability intent action. In another embodiment, the hardware processor executing computer-readable program code instructions of the AI productivity tool software module to invoke a contextual capability modification machine learning (ML) model algorithm to adjust the at least one responsive capability intent action selected to operate based on the detected system/component context telemetry data and the user operating context telemetry data in response to the user query input, whether or not the capability intent action is selected using the system/component context telemetry data and the user operating context telemetry data.

In the context of the present specification, the ML model algorithm execution provider hardware processing resource may be one or a combination of ML model algorithm execution provider hardware processing resources such as a central processing unit (CPU), an embedded controller (EC), a graphics processing unit (GPU), a neural processing unit (NPU), and an audio processing unit (APU), or the like. Some of these hardware processing devices may or may not be included “on-the-box” of the information handling system in some embodiments and the execution of the computer-readable program code instructions of the system state component discovery software application may identify the availability of these hardware devices. The system/component context telemetry data and user operating context telemetry data may be obtained prior to the one or more ML model algorithms being executed by the AI productivity tool software module to select a responsive capability intent action or to modify a selected responsive capability action.

In an embodiment, the ML model algorithm may include a speech-to-text ML model algorithm to convert audio user-query input received at the AI productivity tool software module from a user via a microphone into text. In another embodiment, the ML model algorithm includes a query input-to-intent ML model algorithm invoked to identify an query intent value of the user-query input using, as input, the user-query input in text form. In some embodiments, additional input including system/component context telemetry data and user operating context telemetry data may be used in generating the query intent value in a multi-axis vector space that is used to identify a user intent presented by the user in the user-query input. In still another embodiment, the ML model algorithm includes a query intent-to-capability ML algorithm to use, as input, the user query intent vector identified via the query input-to-intent ML model algorithm. Execution of, and any capability modification metrics associated with each of a gathered list of capabilities of AI productivity tool-enablable software applications executing on an information handling system. The capability modification metrics for each capability of AI productivity tool-enablable software applications may correspond to the various types or levels of system/component context telemetry data and user operating context telemetry data and may assist in identifying and selecting the responsive capability intent action to the received user query input.

In an embodiment, the systems and methods may also include a plurality of hardware drivers operatively coupled to the system component and user context discovery software application to send the system/component context telemetry data and user operating context telemetry data to the system component and user context discovery software application. Additionally, in some embodiments, a plurality of sensors may be operatively coupled to the system component and user context discovery software application to send the system/component context telemetry data to the system component and user context discovery software application.

In an embodiment, the hardware processor may execute the computer readable program code instructions of the system component and user context discovery software application to request and register capabilities associated with each of the plurality of AI productivity tool-enablable software applications in a AI productivity tool capabilities database. In an embodiment, these registered capabilities may include associated capability modification metrics in the AI productivity tool capabilities database to assist in similarity matching with query intent values for a user query input and current contextual telemetry data.

Once a responsive capability and the to a user query input is selected by the AI productivity tool software module, the execution of the system component and user context discovery software application may present the current system/component context telemetry data and user operating context telemetry data to the AI productivity tool-enable software application tasked with executing the responsive capability intent action. In an embodiment, the hardware processor executing computer-readable program code instructions of the system component and user context discovery software application may communicate with any of a plurality of AI productivity tool-enablable software applications to trigger capability modification metrics associated with the selected responsive capability intent action of each of the AI productivity tool-enablable software applications to define how each responsive capability intent action can be modified when detected current system/component context telemetry data and user operating context telemetry data meets the capability modification metrics for that responsive capability intent action. In this way, the AI productivity tool software module may respond to received user query inputs with the selection of a responsive capability intent action that may be modified after selection by the current system/component context telemetry data and user operating context telemetry data detected for the information handling system in other embodiments of the present disclosure.

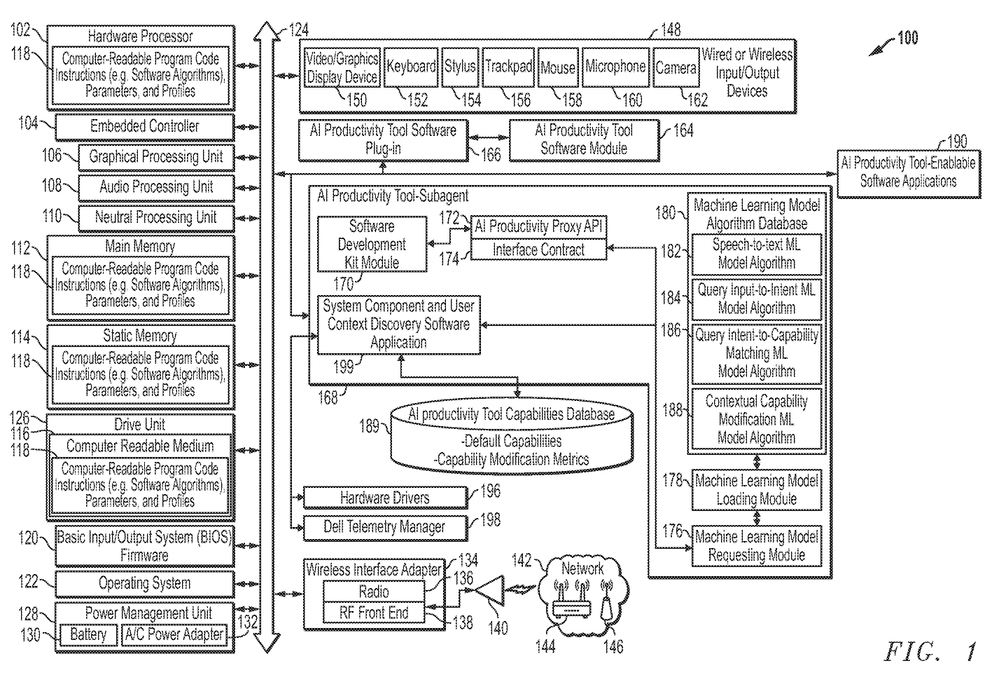

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify capability intent actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or static memory 114, nonvolatile (read-only memory, flash memory etc.) or any combination thereof), one or more hardware processing resources, such as a hardware processor 102 (e.g., central processing unit (CPU)), an embedded controller (EC) 104, a graphics processing unit (GPU) 106, a neural processing unit (NPU) 110, an accelerated processing unit (APU) 108, other types of hardware processing devices, or any combination thereof. It is appreciated that the information handling system 100 may include any number of hardware processing devices described herein. Computer readable code instructions stored in main memory 112 (e.g., RAM) may be quickly accessible by hardware processing resources using that main memory 112. Computer-readable program code instructions stored in static memory 114, main memory 112, or drive unit 126 may involve some latency in invoking such computer-readable program code instructions to main memory 112 according to embodiments herein. Additional components of the information handling system 100 may include one or more storage devices such as static memory 114 or drive unit 126. The information handling system 100 may include or interface with one or more communications ports for communicating with external devices, as well as various input and output (I/O) devices 148, such as a mouse 158, a trackpad 156, a stylus 154, a keyboard 152, a video/graphics display device 150, a microphone 160, or any combination thereof. Portions of an information handling system 100 may themselves be considered information handling systems 100.

Information handling system 100 may include devices or modules that embody one or more of the devices or execute instructions for one or more systems and modules. The information handling system 100 may execute instructions (e.g., software algorithms), parameters, and profiles 118 that may operate on servers or systems, remote data centers, or on-box in individual client information handling systems according to various embodiments herein. In some embodiments, it is understood any or all portions of instructions (e.g., software algorithms), parameters, and profiles 118 may operate on a plurality of information handling systems 100.

The information handling system 100 may include the hardware processor 102 such as a central processing unit (CPU) or other hardware processing resources. Any of the hardware processing resources may operate to execute code that is either firmware or software code. Moreover, the information handling system 100 may include memory such as main memory 112, static memory 114, and disk drive unit 126 (volatile (e.g., random-access memory, etc.), nonvolatile memory (read-only memory, flash memory etc.) or any combination thereof or other memory with computer readable medium 116 storing instructions (e.g., software algorithms), parameters, and profiles 118 executable by the hardware processor 102 (e.g., central processing unit), NPU, APU, EC 104, GPU 106, or any other hardware processing device. The information handling system 100 may also include one or more buses 124 operable to transmit communications between the various hardware components such as any combination of various I/O devices 148 as well as between hardware processors 102, an EC 104, the operating system (OS) 122, the basic input/output system (BIOS) 120, the wireless interface adapter 134, or a radio module, among other components described herein. In an embodiment, the hardware processor 102, EC 104, GPU 106, NPU, APU, and/or others may execute one or more bus drivers in order to transmit this data between the information handling system 100 and the input/output devices 148 described herein. In an embodiment, the information handling system 100 may be in wired or wireless communication with the I/O devices 148 such a keyboard 152, a mouse 158, video/graphics display device 150, stylus 154, trackpad 156, microphone 160, among other peripheral devices.

As described herein, the information handling system 100 further includes a video/graphics display device 150. The video/graphics display device 150 in an embodiment may function as a liquid crystal display (LCD), an organic light emitting diode (OLED), a flat panel display, or a solid-state display. It is appreciated that the video/graphics display device 150 may be wired or wireless and may be an external video/graphics display device 150 that allows a user to increase the desktop area by extending the desktop in an embodiment. Additionally, as described herein, the information handling system 100 may include or be operatively coupled to a cursor control device (e.g., a trackpad 156, or gesture or touch screen input), a stylus 154, and/or a keyboard 148, among others that allows the user to interface with the information handling system 100 via the video/graphics display device 150. Information handling system 100 may also be operatively coupled to a wired or wireless input/output device 148 or other hardware devices that may include a hardware processing device such as a hardware processor, microcontroller, or other hardware processing resource. Various drivers and hardware control device electronics may be operatively coupled to operate the I/O devices 148 according to the embodiments described herein. The present specification contemplates that the I/O devices 148 may be wired or wireless.

A network interface device of the information handling system 100 may be wired or wireless such as shown with wireless interface adapter 134 that can provide wireless connectivity among devices such as with Bluetooth® or to a network 142, e.g., a wide area network (WAN), a local area network (LAN), wireless local area network (WLAN), a wireless personal area network (WPAN), a wireless wide area network (WWAN), or other network. In embodiments described herein, the wireless interface device 134 with its radio 136, RF front end 138 and antenna 136 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth ®, BLE, proprietary RF protocol, or other WPAN or WLAN protocols and plural such protocols may be used for communication with and among any wireless peripheral device to be paired or paired with the information handling system 100 or other information handling systems.

In other embodiments, a WAN, WWAN, LAN, and WLAN may each include an AP 140 or base station 142 used to operatively couple the information handling system 100 to a network 142 via a wireless interface adapter 134. In a specific embodiment, the network 142 may include macro-cellular connections via one or more base stations 142 or a wireless AP 140 (e.g., Wi-Fi), or such as through licensed or unlicensed WWAN small cell base stations 142. Connectivity may be via wired or wireless connection. For example, wireless network wireless APs 140 or base stations 142 may be operatively connected to the information handling system 100. Wireless interface adapter 134 may include one or more RF (RF) subsystems (e.g., radio 136) with transmitter/receiver circuitry, modem circuitry, one or more antenna RF (RF) front end circuits 138, one or more wireless controller circuits, amplifiers, antennas 136 and other circuitry of the radio 136 such as one or more antenna ports used for wireless communications via multiple radio access technologies (RATs). The radio 136 may communicate with one or more wireless technology protocols.

In an embodiment, the wireless interface adapter 134 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, proprietary RF protocol, or similar wireless standards may be used. Wireless interface adapter 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 134 can represent an add-in card, wireless network interface module that is integrated with a main board of the information handling system 100 or integrated with another wireless network interface capability, or any combination thereof.

In some embodiments, a hardware processing resource executes computer-readable program code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit. Accordingly, the present system encompasses a hardware processing resource executing computer-readable program code instructions of software or firmware as well as hardware implementations or any combination.

In accordance with various embodiments of the present disclosure, the methods described herein may be implemented by firmware or software programs executable by any ML model algorithm execution provider hardware processing resource such as a hardware controller or a hardware processor. For purposes of the present specification, the term ML model algorithm is meant to be understood as any machine learning or artificial intelligence (AI) algorithm that can be invoked or executed by a hardware processor to receive input data, learn from that data, and provide output to perform the processes of execution of the AI productivity tool software module 164 for receiving a user query input and identifying and executing one or more responsive capability intent actions of AI productivity tool-enablable software applications 190 selected or modified by gathered contextual telemetry data as described in embodiments herein. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable program code instructions, parameters, and profiles 118 or receives and executes computer-readable program code instructions, parameters, and profiles 118 responsive to a propagated signal, so that a hardware device connected to a network 142 may communicate voice, video, or data over the network 142. Further, the computer-readable program code instructions, parameters, and profiles 118 may be transmitted or received over the network 142 via the network interface device or wireless interface adapter 134.

The information handling system 100 may include a set of computer-readable program code instructions, parameters, and profiles 118 that may be executed to cause the computer system to perform any one or more of the methods or computer-based functions disclosed herein. For example, computer-readable program code instructions, parameters, and profiles118 may be executed by a hardware processor 102, GPU 106, EC 104 or any other hardware processing resource and may include software agents, or other aspects or components used to execute the methods and systems described herein. Various software modules comprising application computer-readable program code instructions, parameters, and profiles 118 may be coordinated by an OS 122, and/or via an application programming interface (API). An example OS 122 may include Windows ®, Android ®, and other OS types. Example APIs may include Win 32, Core Java API, or Android APIs.

In an embodiment, the information handling system 100 may include a disk drive unit 126. The disk drive unit 126 and may include machine-readable program code instructions, parameters, and profiles 118 in which one or more sets of machine-readable program code instructions, parameters, and profiles 118 such as firmware or software can be embedded to be executed by the hardware processor 102 (e.g., CPU) or other hardware processing devices such as a GPU 106, an EC 104, an NPU 110, an APU 108, or other hardware processing resource device to perform the processes described herein. Similarly, main memory 112 and static memory 114 may also contain a computer-readable medium for storage of one or more sets of machine-readable program code instructions, parameters, or profiles 118 described herein. The disk drive unit 126 or static memory 114 also contain space for data storage. Further, the machine-readable program code instructions, parameters, and profiles 118 may embody one or more of the methods as described herein. In a particular embodiment, the machine-readable program code instructions, parameters, and profiles 118 may reside completely, or at least partially, within the main memory 112, the static memory 114, and/or within the disk drive 126 during execution by the hardware processor 102, EC 104, or GPU 106, NPU 110, APU 108 of information handling system 100.

Main memory 112 or other memory of the embodiments described herein may contain computer-readable medium (not shown), such as RAM in an example embodiment. An example of main memory 112 includes random access memory (RAM) such as static RAM (SRAM), dynamic RAM (DRAM), non-volatile RAM (NV-RAM), or the like, read only memory (ROM), another type of memory, or a combination thereof. Static memory 114 may contain computer-readable medium (not shown), such as NOR or NAND flash memory in some example embodiments. The applications and associated APIs, for example, may be stored in static memory 114 or on the disk drive unit 126 that may include access to a machine-readable code instructions, parameters, and profiles 118 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, APU 108, NPU 110, a video/graphic display device 150, or other wired I/O devices 148 such as the mouse 158, the stylus 154, the keyboard 152, the microphone 160, and the trackpad 156 and other components that may require power when a power button has been actuated by a user. In an embodiment, the PMU 128 may monitor power levels and be electrically coupled to the information handling system 100 to provide this power. The PMU 128 may be coupled to the bus 124 to provide or receive data or machine-readable code instructions. The PMU 128 may regulate power from a power source such as the battery 130 or AC power adapter 132. In an embodiment, the battery 130 may be charged via the AC power adapter 132 and provide power to the components of the information handling system 100, via wired connections as applicable, or when AC power from the AC power adapter 132 is removed.

In a particular non-limiting, exemplary embodiment, the computer-readable medium can include a solid-state memory such as a memory card or other package that houses one or more non-volatile read-only memories. Further, the computer-readable medium can be a random-access memory such as main memory 112 or other volatile re-writable memory such as static memory 114. Additionally, the computer-readable medium can include a magneto-optical or optical medium, such as a disk or tapes or other storage device drive unit 126 to store information received via carrier wave signals such as a signal communicated over a transmission medium. Furthermore, a computer readable medium 114 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described in embodiments herein, the information handling system 100 includes an AI productivity tool software module 164 and an AI productivity tool software plug-in 166 to receive user-query input and provide that user-query input to the AI productivity tool subagent 166. In the embodiments herein, the user-query input may include audio input received from, for example, the microphone 160 or a microphone associated with the camera 162 (e.g., a webcam). In another embodiment, the user-query input may include text input by the user by the keyboard 152. In an embodiment, the execution of the computer-readable program code instructions 118 of the AI productivity tool subagent 168 by the hardware processor 102 or any other hardware processing device selects among a plurality of available ML model algorithms 182, 184, 186, 188 maintained within a ML model algorithm database 180 for use with execution of a plurality of AI productivity tool-enablable software applications 190 according to another embodiment of the present disclosure. As described herein, the computer-readable program code instructions 118 of the AI productivity tool software module 164 and AI productivity tool subagent 168 as well as available ML model algorithms 182, 184, 186, 188 may be executed by a hardware processor 102 or other ML model algorithm execution provider hardware processing resource on the information handling system 100 thereby allowing the processes of the AI productivity tool software module 164 to identify capabilities and respond to received user query inputs according to methods described herein to be carried out on-the-box such that a wired or wireless network connection to a network is not necessary for operation of the method. In another embodiment, some modules, databases, and/or processing resources such as ML model algorithms 182, 184, 186, 188 may be maintained on a remote server such that a wired or wireless network connection can be made with these remote servers and the method may be implemented as described herein.

The AI productivity software tool module 164 may include any artificial intelligence-based productivity tool to assist in interfacing with and execution of one or more AI productivity tool-enablable software applications 190 and receive user query inputs from a user and generate responses as responsive capability intent actions at an information handling system 100. The AI productivity tool software module 164 may be loaded on-the-box by a manufacturer in software and may include chatbot features, virtual assistant features, and other artificial intelligence features that allow a user to provide input to the information handling system 100 and, with generative artificial intelligence processing of the user-query input, execute one or more responsive capabilities that include hardware operations, functions, software services such as by using one or more AI productivity tool-enablable software applications 190. Examples of some types of AI productivity tool software modules 164 may include Cortana ® by Microsoft ®, Copilot ® by Microsoft ®, Siri ® by Apple ® Inc., Gemini ® by Google AI®, ChatGPT ® by OpenAI ®, and Amazon Alexa ® by Amazon ®, among others. It is appreciated that the information handling system 100 may include any proprietary AI productivity tool software module 164 installed by an information handling system 100 manufacturer and used to interface with the information handling system 100 and the operations thereon. In various embodiments, the hardware processor 102 or other alternative hardware processing resources of the information handling system 100 may execute computer-readable program code instructions of the AI productivity tool software module 164 with its AI productivity tool plug-in 166 and monitor for user input for a user query at a microphone 160, keyboard 152, or other input device for the AI productivity tool subagent 168 to engage in determining capability intent actions responsive to the user-query input.

The AI productivity tool software module 164, executing on the hardware processor 102, such as a CPU, or other hardware processing resource (e.g., EC 104, GPU 106, APU 108, or NPU 110), may interface with other hardware components and with the AI productivity tool-enablable software applications 190 as well as the one or more ML model algorithms 182, 184, 186, 188 via an AI productivity tool plug-in 166. The AI productivity tool plug-in 166 may be any software or firmware that allows the AI productivity tool subagent 168 to perform processes of the AI productivity tool software module 164 to determine capability intent actions responsive to a user-query input at the information handling system 100 based on specific types of user-query input (e.g., typed, spoken words, images, etc.) provided from the user, and in embodiments of the present disclosure, based on current system/component context telemetry data and user operating context telemetry data. The AI productivity tool plug-in 166 may be used by the AI productivity tool software module 164 and AI productivity tool subagent 168 to interface with any number of AI productivity tool-enablable software applications 190 executing or executable on the information handling system 100 according to embodiments herein.

Again, the information handling system 100 also includes the AI productivity tool subagent 166 associated with the AI productivity tool software module 162. The AI productivity tool subagent 166 may be any software and/or firmware executable by the hardware processor 102 or other ML model algorithm execution provider hardware processing resources 104, 106, 108, 110 of the information handling system 100 to interface with one or more of the plurality of the AI productivity tool-enablable software applications 190 to provide AI enabled capabilities within those AI productivity tool-enablable software applications 190 for responsive hardware, firmware, or software operations, functions, software services, or responses to user input queries. In an embodiment, the computer-readable program code instructions of the AI productivity tool-enablable software applications 190 may operate wholly “on-box” within the information handling system 100 or be sub-agents on-box for interfacing with remote software systems executing at remote server locations. In an embodiment, the AI productivity tool subagent 168 may be used to direct the execution of various modules in support of one or more identified productivity tool operations by the AI productivity tool-enablable software applications 190 and AI productivity tool software module 164 in responding to user query inputs described herein. Additionally, the AI productivity tool subagent 168 may be provided with access to the BIOS and OS of the information handling system 100. Example of identified productivity tool operations include execution of code instructions of the AI productivity tool software module 164 to determine user-query intent values, match these with generated capability intents, and to execute code instructions of one of the AI productivity tool-enablable software applications 190 to conduct commensurate capability intent actions pursuant to the user’s query input.

In an embodiment, during operation, the hardware processor 102 or other hardware processing resource (e.g., EC 104, GPU 106, CPU, APU 108, or NPU 110) executes computer-readable program code instructions of the AI productivity tool subagent 168. The AI productivity tool subagent 168 may engage with a machine learning model requesting module 176 to have one or more ML model algorithms 182, 184, 186, 188 loaded and executed on the hardware processor in order to, initially, determine the query intent value of a user-query input and to correlate it with a capability intent action to be conducted responsive to the received user-query inputs. The execution of the computer-readable program code instructions of the AI productivity tool subagent 168 may call a software development kit (SDK) module 170. The SDK module 170 may include any computer-readable program code instructions that is executed by the hardware processor 102 or other hardware processing resource to request that a ML model algorithm 182, 184, 186, 188 that may be invoked to support the identification of, in an embodiment, a capability intent action based on received user-query inputs from a user at the AI productivity tool software module 164.

For example, the ML model algorithms 182, 184, 186, 188 may include a query input-to-intent ML model algorithm 184 that receives the user-query input, and with an embedding algorithm generates a vectorized query intent value for the user-query input for later correlation with a capability intent value. In embodiments where the user-query input is in audio form, the AI productivity tool subagent 168 may invoke the execution of a speech-to-text ML model algorithm 182 to initially convert this audio into text for use with the query input-to-intent ML model algorithm 184 to generate the vectorized query intent value for the user-query input for later correlation with a capability intent value as described herein. Further, in some embodiments herein, current system/component context telemetry data and user operating context telemetry data is gathered and determination of the existence of or levels of the current system/component context telemetry data and user operating context telemetry data may also be embedded, with the user query intent, in to the query intent value generated by the query input-to-intent ML model algorithm 184 to select responsive capabilities based, in part, on the current system/component context telemetry data and user operating context telemetry data.

In an example embodiment, the ML model algorithms 182, 184, 186, 188 may also include a query intent-to-capability matching ML model algorithm 186. The query intent-to-capability matching ML model algorithm 186 receives the vectorized query intent value from the execution of the query input-to-intent ML model algorithm 184 as input and then matches the vectorized query intent value to a vectorized capability intent value associated with the AI productivity tool-enablable software application 190 via a similarity correlation algorithm for lexical or semantic matching to identify a responsive capability that can serve as the capability intent action responsive to a user-query input. In embodiments of the present disclosure, the capabilities may include pre-determined capability modification metrics assigned that may correspond to the existence or levels of detected current system/component context telemetry data and user operating context telemetry data. These capability modification metrics are embedded with the vectorized capability intent value along with the descriptions of the capability for a given AI productivity tool-enablable software application 190. This may also further assist in the matching and selection of responsive capability intent action based, in part, on current system/component context telemetry data and user operating context telemetry data according to an embodiment herein.

It is appreciated that the selected ML model algorithms 182, 184, 186, 188 for a similar or common identified AI productivity-tool operation type may satisfy an interface contract 174 requested by the AI productivity tool subagent 168 such that the query intent value from the user-query inputs may be interpreted and an available capability associated with one of the plurality of AI productivity tool-enablable software applications 190 as the capability intent action can be matched to the user’s query input. The interface contract 174 described herein defines the requirements that selected ML model algorithms 182, 184, 186, 188 are to have in order to be able receive a specific type of input from the AI productivity tool software module 164, the AI productivity tool subagent 168, or any AI productivity tool-enablable software application 190 and to provide a specific type of output to the AI productivity tool subagent 168, the AI productivity tool software module 164, and/or AI productivity tool-enablable software applications 190. In an embodiment, the interface contract 174 is generated by an AI productivity proxy API 172 invoked by the SDK module 170 in order to identify the similar or common productivity-tool operation type ML model algorithms 182, 184, 186, 188 that provides the appropriate output to the AI productivity tool subagent 168.

As described herein, the AI productivity tool subagent 168 includes a system component and user context discovery software application 199. Execution of the computer-readable program code instructions of the system component and user context discovery software application 199 may help to select or identify modifications to an identified capability that is responsive to the user-query input with the invoked ML model algorithm 182, 184, 186, 188 using, as input, system/component context telemetry data and user operating context telemetry data gathered by the system component and user context discovery software application 199 to identify the responsive capability intent action. In order to obtain the system/component context telemetry data and user operating context telemetry data, the system component and user context discovery software application 199 may be operatively coupled to any number of hardware drivers 196 and/or a Dell® telemetry manager 198. In an embodiment, the system/component context telemetry data and user operating context telemetry data may also be received from any other hardware or firmware device that can provide the telemetry data described herein. For example, each of the hardware drivers 196 may be operatively coupled to hardware device that provides telemetry data that describes the current and historic operation of the hardware device. In a specific example embodiment, a hardware driver 196 may be associated with the PMU 128 that identifies specific voltage levels as well as a current charge state of the battery 130, historic battery charge usage 130, current charging rate of the battery 130, current battery 130 temperatures (e.g., via a thermal sensor), current battery charging/use mode (e.g., balanced, high performance, power saver, battery saver, adaptive, custom, and primarily A/C modes), as well as a relative state of charge (RSOC) of the battery. In another specific example embodiment, the hardware driver 196 may include any driver software associated with any hardware processing device (e.g., 102, 104, 106, 108, 110) that describes historic and current processing consumption.

In an embodiment, the Dell® telemetry manager 198 or other telemetry monitoring service executing on the information handling system may help to manage the collection of system/component context telemetry data and/or user operating context telemetry data. For example, the Dell® telemetry manager 198 may be operatively coupled to one or more sensors that monitor the current state of hardware component devices in an information handling system. In a specific example, the Dell® telemetry manager 198 may be operatively coupled to a temperature measuring device (e.g., a thermistor) that measures temperatures of hardware component devices within the information handling system such as the battery 130 or a hardware processing device (e.g., 102, 104, 106, 108, 110). Another sensor may include an accelerometer that may determine the position and/or movement of the information handling system 100. This this system/component context telemetry data may be used as input into any ML model algorithm 182, 184, 186, 188 by the AI productivity tool subagent 168 as part of selecting and identifying an appropriate responsive capability intent action responsive to the user-query input received at the AI productivity tool software module 164 or in triggering modifications to a selected responsive capability intent action.

In an embodiment, the user operating context telemetry data may include any data related to the user operating the information handling system and current and historic software application use. For example, the user operating context telemetry data may include data describing the current active user operating the information handling system 100 (e.g., by user login information provided), user login/logout status and history, current and historic software application usage execution by the user on the information handling system 100, current user preferences and settings, among other user-related operating characteristics. Again, this user operating context telemetry data may be used as input in an ML model algorithm (182, 184, 186, 188) by the AI productivity tool subagent 168 in order to identify an appropriate responsive capability intent action responsive to the user-query input received at the AI productivity tool software module 164 or in triggering modifications to a selected responsive capability intent action.

With the gathered system/component context telemetry data and user operating context telemetry data, the system component and user context discovery software application 199 may provide this data to the AI productivity tool subagent 168 to be used as additional input when the AI productivity tool software module 164 has received a user-query input from the user to determine a query intent value in some embodiments. In an embodiment, the system component and user context discovery software application 199 may also provide system/component context telemetry data and user operating context telemetry data related to the modification of selected capabilities of each of the AI productivity tool-enablable software applications 190 as well as any other AI productivity tool software module. This system/component context telemetry data and user operating context telemetry data related to the modification of selected capabilities of these software applications may trigger if and how each of the AI productivity tool-enablable software applications 190 and/or AI productivity tool software modules is to be modified to address a user’s user-query input.

Each application capability of the AI productivity tool-enablable software applications 190 may include capability modification metrics stored in an AI productivity tool capability database 189 that describe how and to what extent these application capabilities may be modified in order to customize the responsive capability intent action based on the received user-query input and detected system/component context telemetry data and user operating context telemetry data. For example, a user may request, at the AI productivity tool software module 164, to “make my system run faster.” As described herein the AI productivity tool software module 164 and AI productivity tool subagent 168 uses this user-query input as well as system/component context telemetry data and user operating context telemetry data to determine the user’s intent via invocation of one or more ML model algorithms such as the speech-to-text ML model algorithm 182, the query input-to-intent ML model algorithm 184 to determine a query intent value within the context of the system/component context telemetry data and user operating context telemetry data. The query intent-to-capability matching ML model algorithm 186 may then be invoked to match the query intent value to capability intent values derived from descriptions of the application capabilities of AI productivity tool-enablable software applications as well as their associated capability modification metrics.

As described herein, the speech-to-text ML model algorithm 182 may be used to convert the user’s spoken words of “make my system run faster” into individual words in the form of text. Once the user-query input (e.g., in audio format) is converted into text, the invocation of the query input-to-intent ML model algorithm 184 receives that identified text of the user-query input, and with an embedding algorithm generates a vectorized query intent value for the user-query input for later correlation with a capability intent value. In some embodiments herein, the query input-to-intent ML model algorithm 184 receives both text of the user query input as well as system/component context telemetry data and user operating context telemetry data as input to generate a vectorized query intent value that includes contextual information about hardware, software, and user of the information handling system. Invocation of the query intent-to-capability matching ML model algorithm 186 receives the vectorized query intent value, with or without the contextual information in various embodiments, from the execution of the query input-to-intent ML model algorithm 184 and uses the same as input to similarity match the vectorized query intent value to a vectorized capability intent value associated with the AI productivity tool-enablable software application 190 via a similarity correlation algorithm for lexical or semantic matching. In some embodiments, the vectorized capability intent values may also include the capability modification metrics as well. The best matched or similarity matched applications capabilities above a threshold correlation level thus identify the one or more responsive capability that can serve as the capability intent action or actions responsive to a user-query input.

In other embodiments herein, however, the system/component context telemetry data and user operating context telemetry data may be used, along with the identified capability intent action and its capability modification metrics, as input to the contextual capability modification ML model algorithm 188. The contextual capability modification ML model algorithm 188 operates to similarity-match the system/component context telemetry data or user operating context telemetry data to a capability modification metric that triggers modification of that capability intent action based on the system/component context telemetry data and user operating context telemetry data. Thus, in the context where the user-query input is “make my system run faster,” the system/component context telemetry data such as the currently-detected RSOC of the battery 130, the currently set thermal mode (e.g., “ultra performance” mode) and the user operating context telemetry data such as the data defining the software application usage history (e.g., to primarily historically use the foreground application by the user) that results in a “foreground optimization” setting being enabled is used as input to further modify the capability intent actions responsive to the user-query input. In an embodiment, the system component and user context discovery software application 199 may maintain an AI productivity tool capabilities database 189 that defines the capabilities of the associated AI productivity tool-enablable software applications 190 and/or other AI productivity tool software modules as well as how those capabilities may be modified (e.g., capability modification metrics). With this data, the invocation of the contextual capability modification ML model algorithm 188 causes the identified capability intent actions responsive to the user-query input to be modified based on the system/component context telemetry data and the user operating context telemetry data.

In an embodiment, the system component and user context discovery software application 199 may automatically receive or have pre-established registered capabilities associated with each of the AI productivity tool-enablable software applications 190 and other AI productivity tool software modules and include defined contextual capability modification metrics. This may allow the AI productivity tool-enablable software applications 190 and/or other AI productivity tool software modules to receive the instructions to execute a modification of a specific capability at run-time based on the received system/component context telemetry data and user operating context telemetry data as arguments to the capabilities and change or modify that capability’s behavior based on this system/component context telemetry data and user operating context telemetry data detected by the system component and user context discovery software application 199. Once the responsive capability is identified via invocation of the query intent-to-capability matching ML model algorithm 186, the capability, its default state, and any capability modification metrics may be used as input to the contextual capability modification ML model algorithm 188 along with the system/component context telemetry data and user operating context telemetry data in order to identify the specific modification to the capability (if any) appropriate for the current operating status of the information handling system 100.

The systems and methods described herein allows the AI productivity tool software module 164 and AI productivity tool subagent 168 to select among plural capabilities as well as fine tune any selected responsive capabilities based on the system/component context telemetry data and user operating context telemetry data indicating current operating status of the information handling system 100. This allows the user to execute software applications via the AI productivity tool software module 164 at the information handling system 100 such that the information handling system 100 may complete responsive capability intent actions in a manner that considers the user’s habits and the system abilities. Additionally, the user is not required to provide specific details in their user-query input in order to customize the capabilities of the AI productivity tool-enablable software applications 190 and other AI productivity tool software modules because the system/component context telemetry data and user operating context telemetry data provides context that infers specific modifications to settings and operating parameters of the information handling system 100. Thus, the AI productivity tool subagent 168 invoking the contextual capability modification ML model algorithm 188 implements the system/component context telemetry data and user operating context telemetry data automatically in order to customize the responsive capability intent action even if the user-query input is the same or generically worded in some embodiments.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel ® brand processor, AMD ® brand processors, Qualcomm ® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

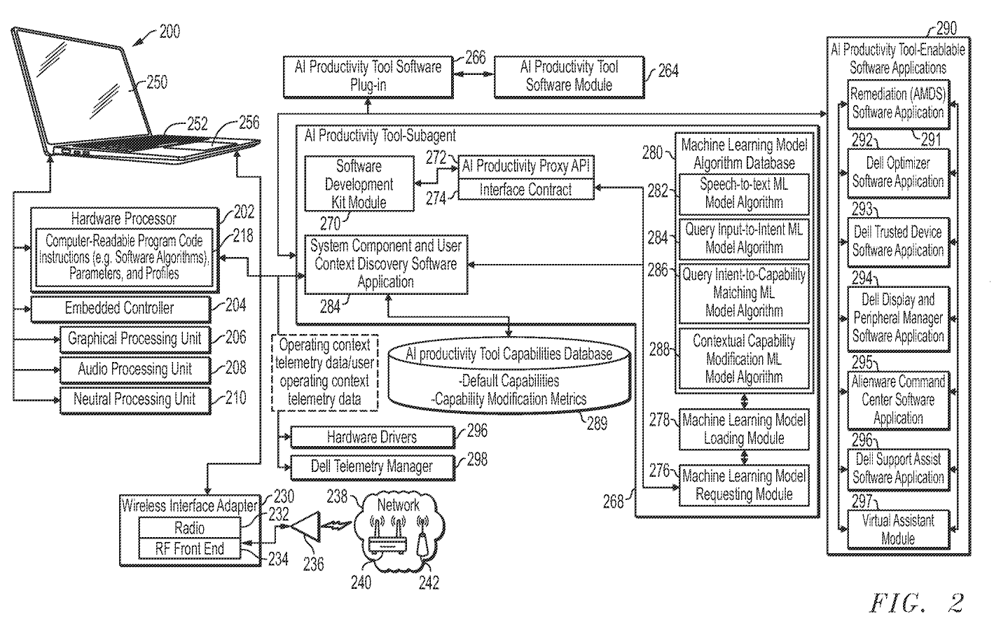

FIG. 2 is a graphic and block diagram illustrating an information handling system 200 that includes computer-readable program code instructions of an AI productivity software module to receive a user query input and contextual telemetry data of the information handling system to determine one or more responsive software services, hardware operations, or other capabilities to the user query input and selected or adapted based on the contextual telemetry data according to embodiments herein. A hardware processor 202 on an information handling system 100 executes computer readable code instructions of an AI productivity tool software module 264 to identity, select among, and adapt an application capability intent action of one or more AI productivity tool-enablable software applications 290 or other AI productivity tool software modules 290 (e.g., 291, 292, 293, 294, 295, 296, 297) for responsive software services, operations, or other capabilities to respond to a received user query input based on system/component context telemetry data and/or user operating context telemetry data gathered by a system component and user context discovery software application 284 according to embodiments of the present disclosure. Examples of AI productivity tool-enablable software applications 290 include a remediation (AMDS) software application 291, Dell ® Optimizer ® software application 292, Dell ® Trusted Device ® software application 293, Dell ® Display and Peripheral Manager ® software application 294, Alienware® Command Center ® (AWCC) software application 295, Dell ® Support Assist ® software application 196, and a virtual assistant module 297. As shown in FIG. 2, the information handling system 200 may be a laptop-type information handling system 200. This laptop-type information handling system 200 may include a built-in video/graphics display device 250, a built-in keyboard 252, and a built-int trackpad 256 used by the user to provide input, including the user-query input, to the information handling system 200.

As described in embodiments herein, the information handling system 200 includes an AI productivity tool software module 264 and an AI productivity tool software plug-in 266 to receive user-query input and provide that user-query input to the AI productivity tool subagent 266. In an embodiment, the AI productivity tool software module 264 may be a chatbot that can receive audio user-query input, text user-query input, image user-query input, or other types of user-query input from the user. In the embodiments herein, the user-query input may include audio input received from, for example, the microphone or a microphone associated with the camera (e.g., a webcam). In another embodiment, the user-query input may include text input by the user by the keyboard 252.

As described in embodiments herein, the execution of the computer-readable program code instructions 218 of the AI productivity tool subagent 268 by the hardware processor 202 or any other hardware processing device selects among a plurality of available ML model algorithms 282, 284, 286, 288 maintained within a ML model algorithm database 280 to conduct selection and identification of a responsive application capability to be executed by one a plurality of AI productivity tool-enablable software applications 290 (e.g., 291, 292, 293, 294, 295, 296, 297) responsive to a user query input. In an embodiment, the computer-readable program code instructions 218 of the AI productivity tool software module 264 and AI productivity tool subagent 268 as well as available ML model algorithms 282, 284, 286, 288 may be executed by a hardware processor 202 or other ML model algorithm execution provider hardware processing resource on the information handling system 200 to receive a user query input and identify a responsive capability intent action tailored with contextual system/component or user information thereby allowing the methods described herein to be carried out on-the-box such that a wired or wireless network connection to a network is not necessary for operation of the method. In another embodiment, some modules, databases, and/or processing resources such as ML model algorithms 282, 284, 286, 288 may be maintained on a remote server such that a wired or wireless network connection can be made with these remote servers and the method may be implemented as described herein.

The AI productivity software tool module 264 may include any artificial intelligence-based productivity tool or software application to assist in interfacing with and execution of one or more AI productivity tool-enablable software applications 290 and receive inputs from a user and generate responses at an information handling system 200. The AI productivity tool software module 264 may be loaded on-the-box by a manufacturer in software and may include chatbot features, virtual assistant features, and other artificial intelligence features that allow a user to provide input to the information handling system 200 and, with generative artificial intelligence processing of the user-query input, execute one or more capabilities that include hardware operations, functions, software services, or responses using one or more AI productivity tool-enablable software applications 290. It is appreciated that the information handling system 200 may include any proprietary AI productivity tool software module 264 installed by an information handling system 200 manufacturer and used to interface with the information handling system 200 and the operations thereon. In various embodiments, the hardware processor 202 or other alternative hardware processing resources of the information handling system 200 may execute computer-readable program code instructions of the AI productivity tool software module 264 with its AI productivity tool plug-in 266 and monitor for user input for a user query at a microphone, the keyboard 252, or other input device for the AI productivity tool subagent 268 to engage in determining selection of capability intent actions responsive to the user-query input and modifying those capabilities based on gathered system/component context telemetry data and user operating context telemetry data.

The AI productivity tool software module 264, executing on the hardware processor 202, such as a CPU, or other hardware processing resource (e.g., EC 204, GPU 206, APU 208, or NPU 210), may interface with other hardware components and with the AI productivity tool-enablable software applications 290 as well as the one or more ML model algorithms 282, 284, 286, 288 via an AI productivity tool plug-in 266. The AI productivity tool plug-in 266 may be any software or firmware that allows the AI productivity tool subagent 268 to perform those actions responsive to a user-query input at the information handling system 200 based on specific types of user-query input (e.g., typed, spoken words, images, etc.) provided from the user. The AI productivity tool plug-in 266 may be used by the AI productivity tool software module 264 and AI productivity tool subagent 268 to interface with any number of AI productivity tool-enablable software applications 290 executing or executable on the information handling system 200 according to embodiments herein.

During operation of the information handling system 200, a user may provide a user-query input using one of the methods described herein. In a specific non-limiting example, a user may either speak or type the phrase “my game is too slow.” This phrase may be provided to the AI productivity tool software module 264 by the user who is currently experiencing lag time during a gaming experience either with an on-the-box gaming application or an online gaming application. This may be frustrating for the user and the user may be attempting to find out how to increase the experience of the user during this gaming experience.

The AI productivity tool software module 264, having received the user-query input “my game is too slow” may transmit this user-query input to the AI productivity tool subagent 268 via the AI productivity tool software plug-in 266. In an embodiment, during operation, the hardware processor 202 or other hardware processing resource (e.g., EC 204, GPU 206, CPU, APU 208, or NPU 210) executes computer-readable program code instructions of the AI productivity tool subagent 268. The AI productivity tool subagent 268 may engage with a machine learning model requesting module 276 to have one or more ML model algorithms 282, 284, 286, 288 loaded and executed on the hardware processor in order to, initially, determine the query intent value of a user-query input and to correlate it with a capability intent action to be conducted responsive to the received user-query inputs. The system component and user context discovery software application 284 may also collect current operating status of the information handling system 100 including system/component context telemetry data and user operating context telemetry data. This system/component context telemetry data and user operating context telemetry data may be input, with the user query input, to the ML model algorithms to determine the query intent value to include system/component and user contextual information.

The execution of the computer-readable program code instructions of the AI productivity tool subagent 268 may call a software development kit (SDK) module 270. The SDK module 270 may include any computer-readable program code instructions that is executed by the hardware processor 202 or other hardware processing resource to request that a ML model algorithm 282, 284, 286, 288 that may be invoked to support the identification of, in an embodiment, a responsive capability intent action from a user at the AI productivity tool software module 264 based on received user-query inputs and system/component context telemetry data and user operating context telemetry data. In some embodiments, selection of a responsive capability intent action may not necessarily be based on the system/component context telemetry data and user operating context telemetry data, and the system/component context telemetry data and user operating context telemetry data is used instead to adapt or adjust the selected responsive capability intent action as triggered by associate capability modification metrics for that selected responsive capability intent action.

Continuing with the examples presented herein, the ML model algorithms 282, 284, 286, 288 may include a query input-to-intent ML model algorithm 284 that receives the user-query input “my game is too slow,” and with an embedding algorithm generates a vectorized query intent value for the user-query input for later correlation with a capability intent value. In embodiments where the user-query input is in audio form, the AI productivity tool subagent 268 may invoke the execution of a speech-to-text ML model algorithm 282 to initially convert this audio into text or other computer-readable code for use with the query input-to-intent ML model algorithm 284 to generate the vectorized query intent value for the user-query input for later correlation with a capability intent value as described herein. As described, in some embodiments, system/component context telemetry data and user operating context telemetry data is also used as input along with the user query input text to generate the vectorized query intent value to include the system/component or user contextual information.

In an example embodiment, the query intent-to-capability matching ML model algorithm 286 receives the vectorized query intent value from the execution of the query input-to-intent ML model algorithm 284 as input and then matches the vectorized query intent value to a vectorized capability intent value associated with the AI productivity tool-enablable software application 290 via a similarity correlation algorithm for lexical or semantic matching to identify a responsive capability that can serve as the capability intent action responsive to a user-query input. In some further embodiments, the capability intent values for capabilities of the AI productivity tool-enablable software application 290 also include an associated capability modification metric to identify context telemetry data that may trigger adjustments or may correlate to particular system/component context telemetry data and user operating context telemetry data detected at the information handling system.

In the context where the user-query input was “my game is too slow,” a potential capability that could be identified may include a GPU optimizer capability associated with, for example, the Dell® Optimizer ® software application. In some cases, the gaming application the user is executing on the information handling system 200 may be running on the CPU 102 instead of the GPU 206 and the capability of the GPU optimizer of the Dell® Optimizer ® software application may allow for the execution of the gaming application to be switched to the GPU 206 instead. Whatever the capability is that is associated with optimizing the GPU 206, the execution of the query intent-to-capability matching ML model algorithm 286 has identified a capability. This identified capability, according to the systems and methods described herein, may be further modified based on the gathered current system/component context telemetry data and user operating context telemetry data according to embodiments herein.

It is appreciated that the selected ML model algorithms 282, 284, 286, 288 for a similar or common identified AI productivity-tool operation type may satisfy an interface contract 274 requested by the AI productivity tool subagent 268 such that the query intent value from the user-query inputs may be interpreted or embedded and an available capability associated with one of the plurality of AI productivity tool-enablable software applications 290 can be similarity matched to the user’s query input to select the capability intent action. The interface contract 274 described herein defines the requirements that selected ML model algorithms 282, 284, 286, 288 are to have in order to be able receive a specific type of input from the AI productivity tool software module 264, the AI productivity tool subagent 268, or any AI productivity tool-enablable software application 290 and to provide a specific type of output to the AI productivity tool subagent 268, the AI productivity tool software module 264, and/or AI productivity tool-enablable software applications 290. In an embodiment, the interface contract 274 is generated by an AI productivity proxy API 272 invoked by the SDK module 270 in order to identify the similar or common productivity-tool operation type ML model algorithms 282, 284, 286, 288 that provides the appropriate output to the AI productivity tool subagent 268.

In order to modify an identified responsive application capability, the AI productivity tool subagent 268 includes a system component and user context discovery software application 299. Execution of the computer-readable program code instructions of the system component and user context discovery software application 299 may help identify system/component context telemetry data and user operating context telemetry data that trigger capability modification metrics for modifications to an identified, responsive application capability that is responsive to the user-query input. An invoked contextual capability modification ML model algorithm 288 using, as input, system/component context telemetry data and user operating context telemetry data may identify capability modification metrics associated with one or more of the responsive capability intent actions to trigger modification of their execution. Again, in order to obtain this system/component context telemetry data and user operating context telemetry data, the system component and user context discovery software application 299 may be operatively coupled to any number of hardware drivers 296 and/or a Dell® telemetry manager 298 or other information handling system telemetry orchestrator management software. In an embodiment, the system/component context telemetry data and user operating context telemetry data may also be received from any other hardware or firmware device that can provide the telemetry data described herein. For example, each of the hardware drivers 296 may be operatively coupled to hardware device that provides telemetry data that describes the current and historic operation of the hardware device. In a specific example embodiment, a hardware driver 296 may be associated with the PMU 228 that identifies specific voltage levels as well as a current charge state of the battery 230, historic battery charge usage 230, current charging rate of the battery 230, current battery 230 temperatures (e.g., via a thermal sensor), current battery charging/use mode (e.g., balanced, high performance, power saver, battery saver, adaptive, custom, and primarily A/C modes), as well as a relative state of charge (RSOC) of the battery. In another specific example embodiment, the hardware driver 296 may include any driver software associated with any hardware processing device (e.g., 202, 204, 206, 208, 210) that describes historic and current processing consumption.

In an embodiment, the Dell® telemetry manager 298 or other telemetry orchestrator management software may help to manage the collection of system/component context telemetry data and/or user operating context telemetry data from software applications, application BIOS, as well as the hardware drivers 296. For example, the Dell® telemetry manager 298 may be operatively coupled to one or more sensors that monitors the current state of hardware devices. In a specific example, the Dell® telemetry manager 298 may be operatively coupled to a temperature measuring device (e.g., a thermistor) that measures temperatures of hardware devices within the information handling system such as the battery 230 or a hardware processing device (e.g., 202, 204, 206, 208, 210). Another sensor may include an accelerometer that may determine the position and/or movement of the information handling system 200. Any number of telemetry sensors in the information handling system 200 are contemplated. This system/component context telemetry data may be used as input into any ML model algorithm 282, 284, 286, 288 by the AI productivity tool subagent 268 in order to select and identify an appropriate responsive capability intent action responsive to the user-query input received at the AI productivity tool software module 264 or to provide for triggering capability modification metrics for a modification or adjustment to a responsive capability intent action depending on existence or levels of the system/component context telemetry data detected.

In an embodiment, the user operating context telemetry data may include any data related to the user operating the information handling system and current and historic software application use. For example, the user operating context telemetry data may include data describing the current active user operating the information handling system 200 (e.g., by user login information provided), user login/logout status and history, current and historic software application execution by the user on the information handling system 200, current user preferences and settings, among other user-related operating characteristics. It is contemplated that any user specific contextual data may be included in the user operating context telemetry data gathered. Again, this user operating context telemetry data may be used as input in an ML model algorithm (282, 284, 286, 288) by the AI productivity tool subagent 268 in order to identify and select an appropriate responsive capability intent action responsive to the user-query input received at the AI productivity tool software module 264 or to provide for triggering capability modification metrics for a modification or adjustment to a responsive capability intent action depending on existence or levels of the user operating context telemetry data detected.

With the gathered system/component context telemetry data and user operating context telemetry data, the system component and user context discovery software application 299 may provide this data to the AI productivity tool subagent 268 to be used as additional input when the AI productivity tool software module 264 along with the received user-query input from the user.

In an embodiment, the AI productivity tool capabilities database 289 may also include capability modification metric data related to the modification of the application capabilities of each of the AI productivity tool-enablable software applications 290 as well as any other AI productivity tool software module. This capability modification metric data for the application capabilities of these AI productivity tool-enablable software applications 290 may define if and how each of the AI productivity tool-enablable software applications 290 and/or AI productivity tool software modules can be modified to customize responsive application capability selection to address a user’s user-query input. Additionally, this capability modification metric data may describe how and to what extent these capabilities may be modified in order to customize and adapt the responsive capability intent action based on the received user-query input after selection by the AI productivity tool software module 264 in other embodiments.

Continuing with the example presented herein in FIG. 2, a user may provide input, at the AI productivity tool software module 264, stating that “my game is too slow.” As described herein the AI productivity tool software module 264 and AI productivity tool subagent 268 uses this user-query input to determine the user’s intent via invocation of one or more ML model algorithms such as the speech-to-text ML model algorithm 282, the query input-to-intent ML model algorithm 284 to generate a query intent value. Generating this query intent value may include contextual information when system/component context telemetry data and/or user operating context telemetry data is also used as input to query input-to-intent ML model algorithm 284 along with the user query input.

As described herein, the speech-to-text ML model algorithm 282 may be used to convert the user’s spoken words of ““my game is too slow” into individual words in the form of text. Once the user-query input (e.g., in audio format) is converted into text, the invocation of the query input-to-intent ML model algorithm 284 receives that identified text of the user-query input, and with an embedding algorithm generates a vectorized query intent value for the user-query input for later correlation with a capability intent value. As described, the vectorized query intent value can further include information handling system contextual information by including the system/component context telemetry data and/or user operating context telemetry data as input to the query input-to-intent ML model algorithm 284.

Invocation of the query intent-to-capability matching ML model algorithm 286 receives the vectorized query intent value from the execution of the query input-to-intent ML model algorithm 284 as input and then matches the vectorized query intent value to a vectorized capability intent value associated with the AI productivity tool-enablable software application 290 via a similarity correlation algorithm for lexical or semantic matching to identify a responsive capability that can serve as the capability intent action responsive to a user-query input. In another embodiment, contextual data may be included in generating the vectorized capability intent values by including their associated capability modification metric data which correlates to existence or levels of the system/component context telemetry data and/or user operating context telemetry data of the information handling system or the user. In this way, the system/component context telemetry data and/or user operating context telemetry data may be used to conduct similarity matching between user query input and a responsive capability intent action to include custom selections based on the detected system/component context or user operating context information.

In an embodiment, the query intent-to-capability matching ML model algorithm 286 may reference a AI productivity tool capabilities database 289 that includes a listing of capabilities associated with each of the AI productivity tool-enablable software applications 290 or other AI productivity tool software module to . It is appreciated that each of these capabilities stored on the AI productivity tool capabilities database 289 may include default capabilities as well as capability modification metrics that describe if and how each of the default capabilities may be modified in order to customize the responsive capability intent action using the identified capability from the query intent-to-capability matching ML model algorithm 286.

In other embodiments herein, the system/component context telemetry data and user operating context telemetry data may be used, along with the identified, responsive capability intent action, as input to the contextual capability modification ML model algorithm 288 that matches system/component context telemetry data and/or user operating context telemetry data or levels of the same to capability modification metrics to trigger a modification of that capability intent action after selection. Again, the contextual capability modification ML model algorithm 288 may access the AI productivity tool capabilities data base 289 with listed capabilities and associated capability modification metric data. Thus, in the context where the user-query input is ““my game is too slow,” the system/component context telemetry data such as the currently-detected hardware processing resource usage of the executing hardware processor (e.g., 202, 204, 206, 208, 210), the currently set thermal mode (e.g., “ultra performance” mode) at the hardware processing resources, current power availability (e.g., at the battery or A/C source), and the video/graphic display device settings (e.g., refresh rate) as well as the user operating context telemetry data such as the data defining the software application usage history (e.g., primary historic use of only foreground application by a user) that results in a “foreground optimization” setting being enabled is used as input to further modify the capability intent actions responsive to the user-query input. It is appreciated that in the context of the user-query input of “my game is too slow” from the user or any other user query input in embodiments herein, these are just examples of potential system/component context telemetry data and user operating context telemetry data further data may be obtained and considered during the processes described herein.

In an embodiment, the AI productivity tool capabilities database 289 that defines the capabilities of the associated AI productivity tool-enablable software applications 290 and/or other AI productivity tool software modules as well as how those capabilities may be modified (e.g., capability modification metrics) may be established by an information technology decision maker, manufacturer of the AI productivity tool software module 264, or the user or published from the AI productivity tool-enablable software applications 290 in embodiments herein. With this data, the invocation of the contextual capability modification ML model algorithm 288 causes the identified capability intent actions responsive to the user-query input to be modified based on the system/component context telemetry data and the user operating context telemetry data after they are selected as responsive to a user query input. This modification, in the present example embodiment, may adjust the processing resources to better fit the execution of the gaming application, reduce or stop the number of background operations being conducted, and increase fan speed to cool down the executing hardware processor, among other potential responsive capability intent actions based on the identified capability or capabilities and their respective modifications via invocation of the contextual capability modification ML model algorithm 288. Once the responsive capability is identified via invocation of the query intent-to-capability matching ML model algorithm 286, the capability, its default state, and any capability modification metrics may be used as input to the contextual capability modification ML model algorithm 288 along with the system/component context telemetry data and user operating context telemetry data in order to identify the specific modification to the capability (if any) appropriate for the current operating status of the information handling system 200 according to embodiments herein.

The systems and methods described in embodiments herein allows the AI productivity tool software module 264 and AI productivity tool subagent 268 to select responsive application capabilities based on context or to fine tune any selected responsive application capabilities based on the system/component context telemetry data and user operating context telemetry data. This allows the user to execute software applications at the information handling system 200 such that the information handling system 200 may complete those processes in a manner that considers the user’s habits and the system’s abilities. Additionally, the user is not required to provide specific details in their user-query input in order to customize the capabilities of the AI productivity tool-enablable software applications 290 and other AI productivity tool software modules because the system/component context telemetry data and user operating context telemetry data provides context that infers selection of responsive application capabilities or specific modifications to settings and operating parameters of the information handling system 200 during execution of the selected responsive application capabilities. Thus, the AI productivity tool subagent 268 may use system/component context telemetry data and/or user operating context telemetry data to custom select responsive application capabilities or may invoke the contextual capability modification ML model algorithm 288 to implements the system/component context telemetry data and user operating context telemetry data automatically in order to customize the responsive capability intent action even if the user-query input is the same or generically worded.

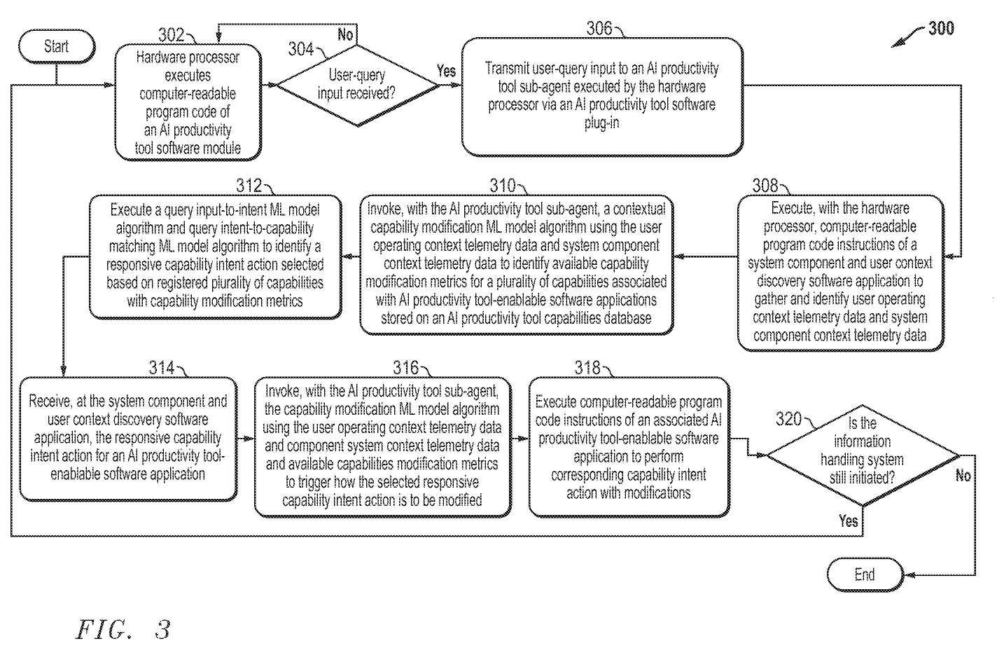

FIG. 3 is a flow diagram showing a method 300 of identifying and selecting among a plurality of application capabilities by execution of code instructions of an AI productivity tool software module using system/component context telemetry data and/or user operating context telemetry data, and adapting at least one selected, responsive capability of one or more an AI productivity tool-enablable software applications responsive to a user query input according to an embodiment of the present disclosure. The method 300 described in connection with FIG. 3 may be operated on an information handling system such as an information handling system (e.g., 100, 200) described in connection with FIGS. 1 or 2. In an embodiment, the systems and methods described herein may operate on the information handling system such that the method is executed “on-the-box” such that a wired or wireless network connection to a network is not necessary for operation of the method. In another embodiment, some modules, databases, and/or processing resources may be maintained on a remote server and a wired or wireless network connection can be made with these remote servers and the method may be implemented as described herein.

The method 300 may include, at block 302, the hardware processor or other hardware processing device of the information handling system executing computer-readable program code instructions of an AI productivity tool software module including access to one or more AI productivity tool-enablable software applications executing on the information handling system. In an embodiment, AI productivity tool software module may be any application that can receive input from a user such as text input via the keyboard, image or touch input via a touchpad, or speech input via the microphone, for example. In some embodiments, text or audio may be received by an interface of the one or more AI productivity tool-enablable software modules and the interface managed by the AI productivity tool sub-agent. In an embodiment, the AI productivity tool software module may include a virtual assistant-type AI software agent. In various embodiments, the hardware processor or other alternative hardware processing resources of the information handling system may execute computer-readable program code instructions of the AI productivity tool software module with its AI productivity tool software plug-in and monitor for user-query inputs at a microphone, keyboard, or other input device for the AI productivity tool subagent to engage in capability intent actions responsive to the user-query inputs.

At block 304, the method 300 also includes determining whether any user-query input has been received at the AI productivity tool software module. Where, at block 304, no user-query input is received, the method 300 returns to block 302 with the AI productivity tool software module continuing to monitor for this input. Where, at block 304, the AI productivity tool software module does detect and receive user-query input, the method 300 continues to block 306 with the user-query input being transmitted to a capability intent identification system such as the AI productivity tool subagent and its modules, algorithms, and software applications being executed by the hardware processor of the information handling system. In an embodiment, the AI productivity tool subagent may orchestrate execution of some or all of the process steps of the AI productivity tool software module in identifying a user query input and identifying a responsive application capability intent action to the user query input as described embodiments herein.

At block 308, the method 300 further includes, with a hardware processor, executing computer-readable program code instructions of the system component and user context discovery software application. Execution of the system component and user context discovery software application causes system/component context telemetry data and user operating context telemetry data to be gathered. In the embodiments of FIG. 3, execution of the computer-readable program code instructions of the system component and user context discovery software application may help identify system/component context telemetry data and/or user operating context telemetry data used to make customized selection of a responsive application capability or to make modifications to an identified, responsive application capability that is responsive to the user-query input. Execution of computer readable code instructions of one or more ML model algorithms may use, as input, the system/component context telemetry data and user operating context telemetry data, along with the user query input text, to identify the responsive capability intent action having matching capability modification metric data associated with it in one embodiment.

In order to obtain the system/component context telemetry data and user operating context telemetry data, the system component and user context discovery software application may be operatively coupled to any number of hardware drivers and/or a Dell® telemetry manager or other information handling system telemetry data orchestration management software in an embodiment. In an embodiment, the system/component context telemetry data and user operating context telemetry data may also be received from any other hardware or firmware device that can provide the telemetry data described herein. For example, each of the hardware drivers may be operatively coupled to a respective hardware device that provides telemetry data that describes the current and historic operation of the hardware device. In a specific example embodiment, a hardware driver may be associated with the PMU that identifies specific voltage levels as well as a current charge state of the battery, historic battery charge usage, current charging rate of the battery, current battery temperatures (e.g., via a thermal sensor), current battery charging/use mode (e.g., balanced, high performance, power saver, battery saver, adaptive, custom, and primarily A/C modes), as well as a RSOC of the battery. In another specific example embodiment, the hardware driver may include any driver software associated with any hardware processing device that describes historic and current processing consumption. It is contemplated that other types of system/component context telemetry data may be obtained that informs the AI productivity tool subagent and is used to identify a plurality of capabilities and modifications of those capabilities thereof associated with any specific AI productivity tool software module that would initiate a responsive capability intent action by the respective AI productivity tool software module.

In an embodiment, the Dell® telemetry manager or other information handling system telemetry data orchestration management software may help to manage the collection of system/component context telemetry data and/or user operating context telemetry data. For example, the Dell® telemetry manager may be operatively coupled to one or more sensors that monitors the current state of hardware devices. In a specific example, the Dell® telemetry manager may be operatively coupled to a temperature measuring device (e.g., a thermistor) that measures temperatures of hardware devices within the information handling system such as the battery or a hardware processing device. Another sensor may include an accelerometer that may determine the position and/or movement of the information handling system. Any number of sensor devices or sensor software systems used in an information handling system for monitoring hardware or software functions are contemplated for providing telemetry data to the system component and user context discovery software application in embodiments herein. Again, this system/component context telemetry data may be used as input into any ML model algorithm by the AI productivity tool subagent in order to identify a plurality of capabilities and modifications of those capabilities thereof associated with any specific AI productivity tool software module as described herein.

In an embodiment, the user operating context telemetry data may include any data related to the user operating the information handling system and current and historic software application use. For example, the user operating context telemetry data may include data describing the current active user operating the information handling system (e.g., by user login information provided), user login/logout status and history, current and historic software application execution by the user on the information handling system, current user preferences and settings, among other user-related operating characteristics. Again, this user operating context telemetry data may be used as input in an ML model algorithm by the AI productivity tool subagent in order to identify a plurality of capabilities and modifications of those capabilities thereof associated with any specific AI productivity tool software module as described herein. It is contemplated that other types of user operating context telemetry data may be obtained that informs the AI productivity tool subagent used to select and identify one or more responsive application capabilities from among a plurality of application capabilities and determine modifications to those selected, responsive application capabilities that would initiate modification to a responsive capability intent action or information handling system settings by an AI productivity tool software module.

At block 310, the method 300 may include invoking, with the AI productivity tool sub-agent, a contextual capability modification ML model algorithm. Invocation of the contextual capability modification ML model algorithm uses, as input, the user operating context telemetry data and system/component context telemetry data to identify available capability modification metrics associated with a plurality of capabilities associated each AI productivity tool-enablable software application or other AI productivity tool software module. These identified capability modification metrics may then be incorporated into vectorized capability intent values for semantic or lexical matching to a query intent value generated from a user query input and system/component context telemetry data and/or user operating context telemetry data. In another embodiment, the capabilities associated with each AI productivity tool-enablable software application may be identified prior with capability modification metric data within an AI productivity tool capabilities database with vectorized capability intent values including the capability modification metric information for access by the query intent-to-capability ML model algorithm for semantic or lexical matching in this process of determining a customized contextual response to received user query inputs.

In an embodiment, at block 312, the AI productivity tool sub-agent may invoke one or more ML model algorithms in order to execute one or more productivity-tool operations to identify the query intent value and match to an appropriate capability intent value of an AI productivity tool-enablable software application that can perform the responsive capability intent action. It is appreciated that, at block 312, the selected ML model algorithms for processes of the AI productivity-tool software module operation type to identify a responsive application capability responsive to a user query input may be required to satisfy an interface contract requested by the AI productivity tool subagent such that the query intent value from the user-query inputs may be interpreted and an available capability associated with one of the plurality of AI productivity tool-enablable software applications as the capability intent action can be matched to the user’s query input. The interface contract described herein defines the requirements that selected ML model algorithms are to have in order to be able receive a specific type of input from the AI productivity tool software module, the AI productivity tool subagent, or any AI productivity tool-enablable software application and to provide a specific type of output to the AI productivity tool subagent, the AI productivity tool software module, and/or AI productivity tool-enablable software applications. In an embodiment, the interface contract is generated by an AI productivity proxy API invoked by the SDK module in order to identify the similar or common productivity-tool operation type ML model algorithms that provides the appropriate output to the AI productivity tool subagent.

In a specific embodiment, execution of computer readable code instructions of the AI productivity tool sub-agent may invoke a query input-to-intent ML model algorithm and query intent-to-capability matching ML model algorithm in order to select and identify a responsive application capability from a plurality of application capabilities associated with a plurality of AI productivity tool software modules that can be executed on the information handling system. To do so, the AI productivity tool sub-agent may use, as input, the user-query input received from the user via an input/output device by the AI productivity tool software module and transmitted to the AI productivity tool sub-agent. In some embodiments, additional input to the query input-to-intent ML model algorithm may include the system/component context telemetry data and/or user operating context telemetry data that may be gathered by execution of computer readable code instructions of the system component and user context discovery software application to include contextual information in a generated query intent value.

The AI productivity tool subagent will further invoke execution of computer readable code instructions of a query intent-to-capability matching ML model algorithm to conduct a semantic or lexical similarity matching algorithm to match the query intent value of the user query input with a capability intent value to determine a responsive application capability according to embodiments herein in an embodiment. In a further embodiment, the capability intent values may include contextual information from capability modification metric data associated with the application capabilities of the AI productivity tool-enablable software applications. In this way, execution of the query intent-to-capability matching ML model algorithm may conduct the semantic or lexical similarity matching algorithm to select a responsive application capability customized to correspond with currently detected system/component context telemetry data and/or user operating context telemetry data in some embodiments. This process will cause the AI productivity tool sub-agent to signal the execution of one or more AI productivity tool-enablable software applications which may then execute one or more responsive capability intent actions that are responsive to the user-query input and selected for the system/component context telemetry data and/or user operating context telemetry data. As described below, these selected, responsive capability intent actions may be further altered via identification of a capability modification triggered by the existence or certain levels of the system/component context telemetry data and/or user operating context telemetry data that would result in a modified capability intent action being executed by the identified and appropriate AI productivity tool-enablable software application according to embodiments herein.

At block 314, the method 300 may include executing the computer readable code instructions of the system component and user context discovery software application to receive the selected responsive application capability associated with an AI productivity tool software module as identified by the AI productivity tool software module as responsive to a user query input. As described herein in some embodiments, the system component and user context discovery software application accesses an AI productivity tool capabilities database that defines the capability modification metric data associated with each of the capabilities of the associated AI productivity tool-enablable software applications executable on the information handling system.

At block 316, the method 300 further includes invoking, with the AI productivity tool sub-agent, the contextual capability modification ML model algorithm using, as input, the user operating context telemetry data and system/component context telemetry data for matching with available capabilities modification metrics for the selected one or more responsive application capabilities to determine if and how the selected responsive application capability is to be modified or the hardware or software systems of the information handling system are to be modified to accommodate the current system/component context telemetry data and/or user operating context telemetry data when the selected responsive application capability intent action is being executed. It is appreciated that any responsive application capability that results in a responsive application capability intent action that may be modified based on the user operating context telemetry data and system/component context telemetry data, existence or levels, that triggers an associated capability modification metric. Once the responsive application capability is identified via invocation of the query intent-to-capability matching ML model algorithm, the application capability and any capability modification metrics may be used as input to the contextual capability modification ML model algorithm along with the system/component context telemetry data and user operating context telemetry data in order to identify the specific modification to the responsive application capability (if any) appropriate for the current operating status of the information handling system or for the identified user.

In an embodiment, the system component and user context discovery software application may access the AI productivity tool capabilities database that defines the application capabilities of the associated AI productivity tool-enablable software applications and/or other AI productivity tool software modules as well as capability modification metrics, if any, for each application capability. The capability modification metrics data for a selected one or more responsive application capabilities may be input to computer readable code instructions for a contextual capability modification ML model algorithm defining how those responsive application capabilities may be modified as triggered by the existence or levels of currently detected system/component context telemetry data and/or user operating context telemetry data. With this data, the invocation of the contextual capability modification ML model algorithm causes the identified modifications to any selected responsive application capability such that identified responsive application capability intent actions responsive to the user-query input may be modified and adjusted based on the system/component context telemetry data and the user operating context telemetry data as described herein.

For example, where the user-query input was “make my game run faster,” one identified responsive application capability may be associated with the Alienware ® Command Center® software application (e.g., 195, FIG. 1) that can switch hardware processing of a gaming application being switched from a CPU to a GPU such that processing resources may be better managed between the two hardware processing resources. Another identified capability may be associated with a Dell® Optimizer ® software application (e.g., 192, FIG. 1) that can also take into account current temperatures of the CPU and GPU such that some or all of the hardware processing requirements should be shared between the CPU and GPU. Thus, in an embodiment, the modification of the responsive application capabilities of either of the above two application capabilities may be modified such that hardware processing levels are increased at the selected one or more hardware processors such as the CPU and the GPU to execute the gaming application but to a modified state by allowing the hardware processing requirements to be shared across the multiple hardware processing resources such as the CPU and GPU but depending on temperature telemetry of either the CPU or GPU as to how much increased processing is allowed. This allowable modification identified by invocation of the contextual capability modification ML model algorithm allows the user’s user-query input to be applied such that the user may observe the information handling system operating at a faster rate, but that also considers both the user operating context telemetry data and the system/component context telemetry data to reduce hardware processes at a single hardware processing device without exceeding current temperatures at any given hardware processing device. It is appreciated that any type of capability or a plurality of capabilities may be modified such that the resulting capability intent actions carried out by the AI productivity tool sub-agent both satisfy the user’s user-query input while also taking into consideration that other contextual data found in the user operating context telemetry data and system/component context telemetry data.

In an embodiment, the system component and user context discovery software application may automatically receive registered application capabilities associated with each of the AI productivity tool-enablable software applications and other AI productivity tool software modules from the AI productivity tool sub-agent. This may allow the AI productivity tool-enablable software applications and/or other AI productivity tool software modules to receive the instructions to execute a specific application capability at run-time and receive the system/component context telemetry data and user operating context telemetry data as arguments to the capabilities and change or modify the selected responsive application capabilities based on this system/component context telemetry data and user operating context telemetry data detected by the system component and user context discovery software application.

At block 318, the corresponding selected, responsive application capabilities with any modifications identified to be executed for responsive capability intent actions to a received user-query input on the information handling system is executed by execution of computer readable code instructions of one or more corresponding AI productivity tool-enablable software applications for those identified responsive capability intent actions. The execution of the corresponding AI productivity tool-enablable software application causes a software action to take place, causes the execution of a software driver to make hardware or firmware setting adjustments, generates a response in text or audio, or executes other responsive actions according to embodiments herein.

At block 320, the method 300 includes determining if the information handling system is still initiated. Where the information handling system is still initiated, the method 300 proceeds to block 302 as described herein. Where the information handling system is no longer initiated, the method 300 may end here.

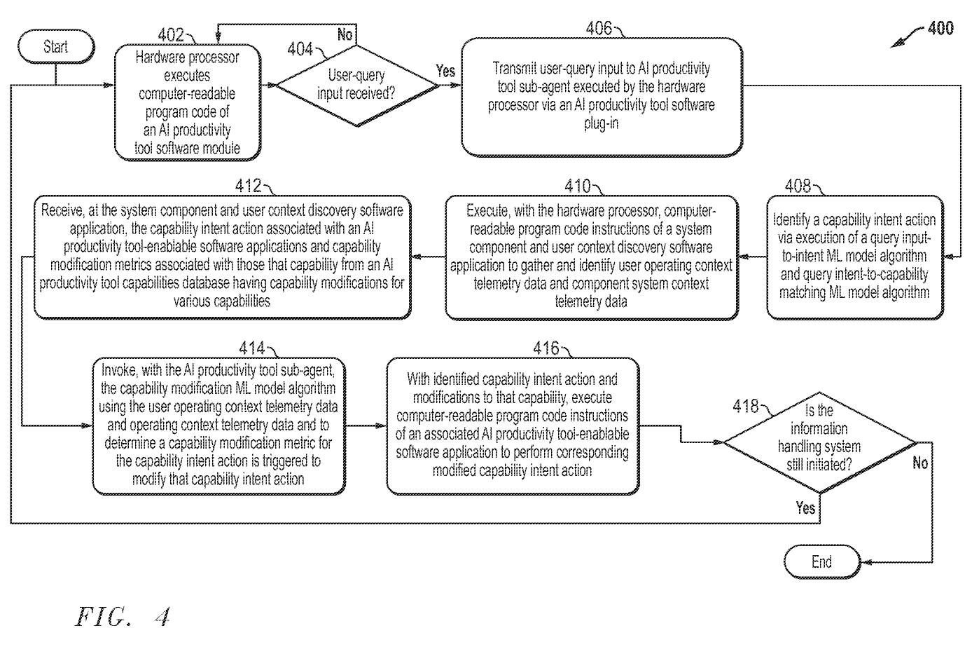

FIG. 4 is a flow diagram showing a method 400 of identifying one or more capabilities of one or more AI productivity tool-enablable software applications by an AI productivity tool software module responsive to a user query input and adapting select responsive capabilities based on gathered system component context telemetry data and/or user operating context telemetry data according to an embodiment of the present disclosure. The method 400 described in connection with FIG. 4 may be operated on an information handling system such as an information handling system (e.g., 100, 200) described in connection with FIGS. 1 or 2. In an embodiment, the systems and methods described herein may operate on the information handling system such that the method is executed “on-the-box” such that a wired or wireless network connection to a network is not necessary for operation of the method. In another embodiment, some modules, databases, and/or processing resources may be maintained on a remote server and a wired or wireless network connection can be made with these remote servers and the method may be implemented as described herein.

The method 400 may include, at block 402, the hardware processor or other hardware processing device of the information handling system executing computer-readable program code instructions of an AI productivity tool software module including access to one or more AI productivity tool-enablable software applications executing on the information handling system. In an embodiment, AI productivity tool software module may be any application that can receive input from a user such as text input via the keyboard, image or touch input via a touchpad, or speech input via the microphone, for example. In some embodiments, text or audio may be received by an interface of the one or more AI productivity tool-enablable software modules and the interface managed by the AI productivity tool sub-agent. In an embodiment, the AI productivity tool software module may include a virtual assistant-type AI software agent. In various embodiments, the hardware processor or other alternative hardware processing resources of the information handling system may execute computer-readable program code instructions of the AI productivity tool software module with its AI productivity tool software plug-in and monitor for user-query inputs at a microphone, keyboard, or other input device for the AI productivity tool subagent to engage in capability intent actions responsive to the user-query inputs.

Therefore, at block 404, the method 400 also includes determining whether any user-query input has been received at the AI productivity tool software module. Where, at block 404, no user-query input is received, the method 400 returns to block 402 with the AI productivity tool software module continuing to monitor for this input. Where, at block 404, the AI productivity tool software module does detect and receive user-query input, the method 400 continues to block 406 with the user-query input being transmitted to a capability intent identification software system such as the AI productivity tool subagent and its modules, algorithms, and software applications being executed by the hardware processor of the information handling system via an AI productivity tool software plug-in. In an embodiment, the capability intent identification software application may be part of an AI productivity tool subagent may provide some or all of the AI productivity services as described herein.

In an embodiment, at block 406, the AI productivity tool software module may transmit the user-query input to the AI productivity tool sub-agent executed by the hardware processor via an AI productivity tool software plug-in.

At block 408, the method 400 also includes the hardware processor executing computer readable code instructions of the AI productivity tool sub-agent invoking one or more ML model algorithms in order to identify the query intent value and match to an appropriate capability intent value of an AI productivity tool-enablable software application that can perform the responsive capability intent action. In embodiments where the user-query input is in audio form, the AI productivity tool subagent may invoke the execution of a speech-to-text ML model algorithm to initially convert this audio into text for use with the query input-to-intent ML model algorithm to generate the vectorized query intent value for the user-query input. The vectorized query intent value is used for later correlation with a capability intent value as described herein.

In an example embodiment, the ML model algorithms may also include a query intent-to-capability matching ML model algorithm. The query intent-to-capability matching ML model algorithm receives the vectorized query intent value from the execution of the query input-to-intent ML model algorithm as input and then matches the vectorized query intent value to a vectorized capability intent value associated with the AI productivity tool-enablable software application via a similarity correlation algorithm for lexical or semantic matching to identify a responsive capability intent value that can serve as the responsive application capability to execute as a responsive application capability intent action responsive to a user-query input.

It is appreciated that the selected ML model algorithms for a similar or common identified AI productivity-tool operation type may satisfy an interface contract requested by the AI productivity tool subagent such that the query intent value from the user-query inputs may be interpreted and an available capability associated with one of the plurality of AI productivity tool-enablable software applications as the capability intent action can be matched to the user’s query input. The interface contract described herein defines the requirements that selected ML model algorithms are to have in order to be able receive a specific type of input from the AI productivity tool software module, the AI productivity tool subagent, or any AI productivity tool-enablable software application and to provide a specific type of output to the AI productivity tool subagent, the AI productivity tool software module, and/or AI productivity tool-enablable software applications. In an embodiment, the interface contract is generated by an AI productivity proxy API invoked by the SDK module in order to identify the similar or common productivity-tool operation type ML model algorithms that provides the appropriate output to the AI productivity tool subagent.

At block 410, the method 400 further includes, with a hardware processor, executing computer-readable program code instructions of the system component and user context discovery software application. Execution of the system component and user context discovery software application causes system/component context telemetry data and user operating context telemetry data to be gathered. In an embodiment, execution of the computer-readable program code instructions of the system component and user context discovery software application may help identify modifications to an identified capability that is responsive to the user-query input with the invoked contextual capability modification ML model algorithm using, as input, system/component context telemetry data and user operating context telemetry data to identify whether the existence of or a level of the system/component context telemetry data and user operating context telemetry data triggers a capability modification metric associated with the responsive capability intent action.

In order to obtain the system/component context telemetry data and user operating context telemetry data, the system component and user context discovery software application may be operatively coupled to any number of hardware drivers and/or a Dell® telemetry manager. In an embodiment, the system/component context telemetry data and user operating context telemetry data may also be received from any other hardware or firmware device that can provide the telemetry data described herein. For example, each of the hardware drivers may be operatively coupled to hardware device that provides telemetry data that describes the current and historic operation of the hardware device. In a specific example embodiment, a hardware driver may be associated with the PMU that identifies specific voltage levels as well as a current charge state of the battery, historic battery charge usage, current charging rate of the battery, current battery temperatures (e.g., via a thermal sensor), current battery charging/use mode (e.g., balanced, high performance, power saver, battery saver, adaptive, custom, and primarily A/C modes), as well as a RSOC of the battery. In another specific example embodiment, the hardware driver may include any driver software associated with any hardware processing device that describes historic and current processing consumption. It is appreciated that other types of system/component context telemetry data may be obtained that informs the AI productivity tool subagent to identify a capability and modifications thereof that would initiate a responsive capability intent action by an AI productivity tool software module and the present specification contemplates these other system/component context telemetry data.

In an embodiment, the Dell® telemetry manager may help to manage the collection of system/component context telemetry data and/or user operating context telemetry data. For example, the Dell® telemetry manager may be operatively coupled to one or more sensors that monitors the current state of hardware devices. In a specific example, the Dell® telemetry manager may be operatively coupled to a temperature measuring device (e.g., a thermistor) that measures temperatures of hardware devices within the information handling system such as the battery or a hardware processing device. Another sensor may include an accelerometer that may determine the position and/or movement of the information handling system. This this system/component context telemetry data may be used as input into any ML model algorithm by the AI productivity tool subagent in order to identify an appropriate responsive capability intent action responsive to the user-query input received at the AI productivity tool software module.

In an embodiment, the user operating context telemetry data may include any data related to the user operating the information handling system and current and historic software application use. For example, the user operating context telemetry data may include data describing the current active user operating the information handling system (e.g., by user login information provided), user login/logout status and history, current and historic software application execution by the user on the information handling system, current user preferences and settings, among other user-related operating characteristics. Execution of a system state monitoring service may track historic usage of software applications and user preferences for settings at the operating system while a security service software may track identification of the user during a login or biometric recognition. Again, this user operating context telemetry data may be used as input in an ML model algorithm by the AI productivity tool subagent in order to identify an appropriate responsive capability intent action responsive to the user-query input received at the AI productivity tool software module. It is appreciated that other types of user operating context telemetry data may be obtained that informs the AI productivity tool subagent used to identify a capability and modifications thereof that would initiate a responsive capability intent action by an AI productivity tool software module and the present specification contemplates these other system/component context telemetry data.

At block 412, the method 400 may include receiving, at the system component and user context discovery software application, the selected, responsive one or more application capabilities determined responsive to a user query input by the AI productivity tool software module and the capability modification metrics associated with each of those selected application capabilities as determined from an AI productivity tool capabilities database. In an embodiment, the system component and user context discovery software application may maintain an AI productivity tool capabilities database that defines the capabilities of the associated AI productivity tool-enablable software applications as well as how those capabilities may be modified via included capability modification metrics. With this data, the invocation of the contextual capability modification ML model algorithm causes the identified responsive capability intent actions responsive to the user-query input to be modified based on the system/component context telemetry data and the user operating context telemetry data state existence or levels triggering one or more capability modification metrics.

In an embodiment, the system component and user context discovery software application may automatically receive registered application capabilities associated with each of the AI productivity tool-enablable software applications and other AI productivity tool software modules. This may allow the AI productivity tool-enablable software applications to receive the instructions from an AI productivity tool software module to execute a specific responsive application capability at run-time and receive the system/component context telemetry data and user operating context telemetry data as arguments to the capability modification metrics and change or modify the execution of the corresponding responsive application capability behavior based on this system/component context telemetry data and user operating context telemetry data state or levels as detected by the system component and user context discovery software application.

In another embodiment, the system component and user context discovery software application may automatically receive registered capabilities associated with each of the AI productivity tool-enablable software applications and other AI productivity tool software modules as well as any potential modifications possible with each associated capability. Once the responsive capability is identified via invocation of the query intent-to-capability matching ML model algorithm, the capability, its default state, and any capability modification metrics may be used as input to the contextual capability modification ML model algorithm along with the system/component context telemetry data and user operating context telemetry data in order to identify the specific modification to the capability (if any) appropriate for the current operating status of the information handling system.

For example, at block 414, the AI productivity tool sub-agent may invoke the contextual capability modification ML model algorithm. In an embodiment, the contextual capability modification ML model algorithm may reference an AI productivity tool capabilities database that includes a listing of application capabilities associated with each of the AI productivity tool-enablable software applications. It is appreciated that each of these application capabilities stored on the AI productivity tool capabilities database may include a default application capability as well as one or more capability modification metrics that describe if and how the default capability may be modified during execution or what hardware or firmware settings or other software actions may need to be modified during execution of that application capability when the system/component context telemetry data and user operating context telemetry data is detected or certain levels are detected. The one or more capability modification metrics associated with an application capability of an AI productivity tool-enablable software application is provided in order to customize the responsive application capability intent action using the identified application capability from the query intent-to-capability matching ML model algorithm depending on the currently detected system/component context telemetry data and user operating context telemetry data in embodiments herein.

In the embodiments herein, the system/component context telemetry data and user operating context telemetry data may be used, along with the identified responsive capability intent action, as input to the contextual capability modification ML model algorithm that matches the system/component context telemetry data and user operating context telemetry data, including status or levels of the same, to any capability modification metrics for modification of that responsive application capability intent action. Thus, in the context where the user-query input is “my game is too slow” in a previous example presented herein, the system/component context telemetry data such as the currently-detected hardware processing resource usage of the executing hardware processor, the currently set thermal mode (e.g., “ultra performance” mode) at the hardware processing resources, current power availability (e.g., at the battery or A/C source), and the video/graphic display device settings (e.g., refresh rate) as well as the user operating context telemetry data such as the data defining the software application usage history (e.g., the user historically focusing only on foreground application during gaming) that results in a “foreground optimization” setting being enabled is used as input to further modify the capability intent actions responsive to the user-query input. These modifications may be in addition to the responsive application capability for ramping up CPU or GPU processing or other responsive application capability intent actions to be performed by the AI productivity tool-enablable software application. It is appreciated that in the context of the user-query input of “my game is too slow” from the user, these are just examples of potential system/component context telemetry data and user operating context telemetry data, further data may also be obtained and matched with capability modification metrics during the processes described herein.

At block 416, the corresponding capability with any modifications identified to be executed for a responsive application capability intent action to a received user-query input on the information handling system is executed by execution of computer readable code instructions of a corresponding AI productivity tool-enablable software application. The execution of the corresponding AI productivity tool-enablable software application causes a responsive software application capability intent action in a software execution response to take place, causes the execution of a software driver to make hardware or firmware setting adjustments, generates a response in text or audio, or executes other responsive actions according to embodiments herein. In a non-limiting example, the user-query input from the user may include the user stating that “why is my computer so hot.” One identified responsive application capability (e.g., at block 412) may be associated with the Alienware ® Command Center® software application (e.g., 195, FIG. 1) that can switch hardware processing of a gaming application being switched from a CPU to a GPU such that processing resources may be better managed between the two hardware processing resources with a reduction in power consumption at the battery. Another identified capability may be associated with a Dell® Optimizer ® software application (e.g., 192, FIG. 1) that can also take into account current temperatures of the CPU, GPU, and battery. Thus, in an embodiment, a selection of the capability associated with the Dell® Optimizer ® software application may be more appropriate in order to address the overheating as mentioned in the user-query input.

This responsive application capability may be modified such that hardware processing shared between the CPU and GPU may include a reduction in power consumption at one or both hardware processors, reduction of processor for execution of background applications, or an increase in cooling system operations so as to drive down the temperature associated with the operation of the CPU, GPU, and battery individually. This allowable modification identified by invocation of the contextual capability modification ML model algorithm allows the user’s user-query input to be applied such that the user may observe the information handling system operating at cooler temperatures, but that also considers both the user operating context telemetry data and the system/component context telemetry data relating to power consumption, processing levels, active software applications, or temperature levels to reduce hardware processes while invoking reduced power consumption, slowed processing of background applications, or increase cooling system function for a single hardware processing device without exceeding current temperatures at any given hardware processing device. It is appreciated that any type of capability or a plurality of capabilities may be modified such that the resulting responsive application capability intent actions carried out by the AI productivity tool sub-agent both satisfy the user’s user-query input while also taking into consideration that other data found in the user operating context telemetry data and system/component context telemetry data.

At block 418, the method 400 includes determining if the information handling system is still initiated. Where the information handling system is still initiated, the method 400 proceeds to block 402 as described herein. Where the information handling system is no longer initiated, the method 400 may end here.

The blocks of the flow diagrams of FIGS. 3 and 4 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system comprising:
a hardware processor, a memory device, and a power management unit to provide power to the hardware processor and memory device;
the hardware processor executing computer-readable program code instructions of a system component and user context discovery software application to gather:
system/component context telemetry data describing operating hardware, hardware modes, and hardware resource consumption; and
user operating context telemetry data describing a user operating the information handling system and current and historic software application use by that user;
the hardware processor executing computer-readable program code instructions of an artificial intelligence (AI) productivity tool software module to receive user-query input from a user of the information handling system via an input/output device;
the hardware processor executing computer-readable program code instructions of the AI productivity tool software module to invoke a machine learning (ML) model algorithm to identify a plurality of responsive capabilities of AI productivity-tool enablable software applications responsive to the user-query input and select at least one responsive capability intent action based on input of the system/component context telemetry data and the user operating context telemetry data to select the at least one responsive capability intent action; and
the hardware processor executing computer-readable program code instructions of the AI productivity tool software module to invoke a contextual capability modification machine learning (ML) model algorithm to adjust the at least one responsive capability intent action selected to operate based on the detected system/component context telemetry data and the user operating context telemetry data in response to the user query input.

2. The information handling system of claim 1 further comprising:
the hardware processor executing code instructions of the ML model algorithm including a speech-to-text ML model algorithm to convert audio user-query input received at the AI productivity tool software module from a user via a microphone into text.

3. The information handling system of claim 1 further comprising:
the hardware processor executing code instructions of the ML model algorithm including a query input-to-intent ML model algorithm to identify a query intent value of the user-query input using, as input, the user-query input, system/component context telemetry data, and user operating context telemetry data to identify the query intent value to include system/component context and user context on the information handling.

4. The information handling system of claim 1, further comprising:
the hardware processor executing code instructions of the ML model algorithm including a query intent-to-capability ML algorithm to identify, via similarity matching to a plurality of capability intent values for the plurality of capabilities and to select the at least one responsive capability intent action based on the system/component context telemetry data, and user operating context telemetry data.

5. The information handling system of claim 1 further comprising:
a plurality of hardware drivers operatively coupled to the system component and user context discovery software application to gather the system/component context telemetry data and the user operating context telemetry data and send the system/component context telemetry data and the user operating context telemetry data to the AI productivity tool software module for input into the ML model algorithm to identify the plurality of responsive capabilities of AI productivity-tool enablable software applications responsive to the user-query input and select the at least one responsive capability intent action.

6. The information handling system of claim 1 further comprising:
a plurality of sensors operatively coupled to the system component and user context discovery software application to gather the system/component context telemetry data and send the system/component context telemetry data and the user operating context telemetry data to the AI productivity tool software module for input into the ML model algorithm to identify the plurality of responsive capabilities of AI productivity-tool enablable software applications responsive to the user-query input and select the at least one responsive capability intent action.

7. The information handling system of claim 1 further comprising:
a plurality of hardware drivers operatively coupled to the system component and user context discovery software application to gather the system/component context telemetry data and the user operating context telemetry data and send the system/component context telemetry data and the user operating context telemetry data to the contextual capability modification machine learning (ML) model algorithm to adjust the selected at least one responsive capability intent actions to operate based on the detected system/component context telemetry data and the user operating context telemetry data in response to the user query.

8. The information handling system of claim 1 further comprising:
the hardware processor executing code instructions of a plurality of AI productivity tool-enablable software applications operatively coupled to the system component and user context discovery software application; and
the hardware processor executing computer-readable program code instructions of the system component and user context discovery software application to request and register capabilities and capability modification dependency metrics of each of the capabilities of the AI productivity tool-enablable software applications that define the capabilities and how each capability can be modified based on the system/component context telemetry data and the user operating context telemetry data to execute the at least one responsive capability intent action.

9. The information handling system of claim 1 further comprising:
the hardware processor executing computer-readable program code instructions of the system component and user context discovery software application to request and register capabilities of each of the capabilities of the AI productivity tool-enablable software applications to include a natural language descriptor that defines the capabilities and a current system or user context for each capability in a contextual capability intent value based on the system/component context telemetry data and the user operating context telemetry data; and
the hardware processor executing computer-readable program code instructions of the processor executing code instructions of the AI productivity tool software module including a query intent-to-capability ML algorithm to identify a similarity-matched contextual capability intent value to select the at least one responsive capability intent action.

10. A method of selecting a capability of an artificial intelligence (AI) productivity tool-enablable software application via execution of computer-readable code instructions of an AI productivity tool software module comprising:
executing, with a hardware processor, computer-readable program code instructions of a system component and user context discovery software application to gather:
system/component context telemetry data describing operating hardware, hardware modes, and hardware resource consumption; and
user operating context telemetry data describing a user operating the information handling system and current and historic software application use of the user;
executing, with the hardware processor, the AI productivity tool software module to receive user-query input from a user of an information handling system;
executing computer-readable program code instructions of the system component and user context discovery software application to request and register capabilities and capability modification dependency metrics of each of the capabilities of plural AI productivity tool-enablable software applications on the information handling system that define the capabilities and how each capability can be modified based on the system/component context telemetry data and the user operating context telemetry data to execute the responsive capability intent action;
executing computer-readable program code instructions of the AI productivity tool software module to invoke a machine learning (ML) model algorithm to identify a responsive capability of the AI productivity tool-enablable software application executable as a capability intent action responsive to the user-query input; and
executing computer-readable program code instructions of the AI productivity tool software module to invoke a contextual capability modification ML model algorithm to adjust the capability intent action to operate based on the detected system/component context telemetry data or user operating context telemetry data triggering at least one capability modification dependency metric for the capability intent action.

11. The method of claim 10 further comprising:
executing computer readable code instructions of the ML model algorithm including a speech-to-text ML model algorithm to, with the hardware processor executing the computer-readable program code instructions of the speech-to-text ML model algorithm, convert audio user-query input received at the AI productivity tool software module from a user via a microphone into text.

12. The method of claim 10 further comprising:
executing computer readable code instructions of the ML model algorithm including a query input-to-intent ML model algorithm to identify a query intent value of the user-query input using, as input, the user-query input, system/component context telemetry data, and user operating context telemetry data to identify the query intent value to include system/component context and user context.

13. The method of claim 12 further comprising:
executing the computer-readable program code instructions of the ML model algorithm including a query intent-to-capability ML algorithm to, with the hardware processor, to select from a plurality of similarity-matched capability intent values to select the responsive capability based on the query intent value including system/component context and user context.

14. The method of claim 10 further comprising:
executing the computer-readable program code instructions of the ML model algorithm including a query intent-to-capability ML algorithm to identify a similarity-matched capability intent value to select the responsive capability.

15. The method of claim 10 further comprising:
sending the system/component context telemetry data and user operating context telemetry data to the system component and user context discovery software application via a plurality of hardware drivers operatively coupled to the system component and user context discovery software application.

16. An information handling system comprising:
a hardware processor, a memory device, and a power management unit to provide power to the hardware processor and memory device;
the hardware processor executing computer-readable program code instructions of a system component and user context discovery software application to gather:
system/component context telemetry data describing operating hardware, hardware modes, and hardware resource consumption; and
user operating context telemetry data describing a user operating the information handling system and current and historic software application use by that user;
the hardware processor executing an artificial intelligence (AI) productivity tool software module to receive user-query input from a user of the information handling system via an input/output device;
the hardware processor executing computer-readable program code instructions of the AI productivity tool software module to identify and select a responsive capability of an AI productivity-tool enablable software application on the information handling system for execution of a capability intent action that is responsive to the user-query input; and
the hardware processor executing computer-readable program code instructions of the AI productivity tool software module to invoke a contextual capability modification machine learning (ML) model algorithm to adjust the capability intent action to operate based on the detected system/component context telemetry data and user operating context telemetry data in response to the user query input, wherein the invoked contextual capability modification ML model algorithm uses, as input, the system/component context telemetry data and user operating context telemetry data to adapt the responsive capability intent action execution on the information handling system.

17. The information handling system of claim 16 further comprising:
the processor executing code instructions of the AI productivity tool software module including a query input-to-intent ML model algorithm to identify a query intent value of the user-query input using, as input, the user-query input, system/component context telemetry data, and user operating context telemetry data to identify the query intent value to include system and user context; and
the processor executing code instructions of the AI productivity tool software module including a query intent-to-capability ML algorithm to identify a similarity-matched capability intent value to select the responsive capability.

18. The information handling system of claim 16 further comprising:
a plurality of sensors operatively coupled to the system component and user context discovery software application to gather the system/component context telemetry data and the user operating context telemetry data and send the system/component context telemetry data and the user operating context telemetry data to the contextual capability modification ML model algorithm to adjust the responsive capability intent action to operate based on the detected system/component context telemetry data at the information handling system and the user operating context telemetry data of the user in response.

19. The information handling system of claim 16 further comprising:
the hardware processor executing computer-readable program code instructions of the system component and user context discovery software application to request and register capabilities and capability modification dependency metrics of each of the capabilities of the AI productivity tool-enablable software applications that define the capabilities and how each capability can be modified based on the system/component context telemetry data and the user operating context telemetry data during execution of the responsive capability intent action; and
the hardware processor executing computer-readable program code instructions of the AI productivity tool software module to invoke the contextual capability modification machine learning (ML) model algorithm to adjust execution of the capability intent action by a first AI productivity tool-enablable software application in response to the user query input based on the detected system/component context telemetry data or user operating context telemetry data triggering at least one capability modification dependency metric.

20. The information handling system of claim 16 further comprising:
the hardware processor executing computer-readable program code instructions of the system component and user context discovery software application to request and register capabilities and capability modification dependency metrics of each of the capabilities of the AI productivity tool-enablable software applications to include a natural language descriptor that defines the capabilities and a current system or user context for each capability in a contextual capability intent value based on the system/component context telemetry data and the user operating context telemetry data; and
the hardware processor executing computer-readable program code instructions of the processor executing code instructions of the AI productivity tool software module including a query intent-to-capability ML algorithm to identify a similarity-matched contextual capability intent value to select the responsive capability.
